(19) United States
(12) Patent Application Publication
(10) Pub. No.: US 2025/0261192 A1
(43) Pub. Date: Aug. 14, 2025

(54) SYSTEM INFORMATION BLOCK AND ULTRA COMPACT DOWNLINK CONTROL INFORMATION DESIGNS FOR NON-TERRESTRIAL NETWORK ENHANCEMENTS

(71) Applicant: APPLE INC., Cupertino, CA (US)

(72) Inventors: Chunxuan Ye, San Diego, CA (US); Wei Zeng, San Diego, CA (US); Dan Zhang, San Diego, CA (US); Oghenekome Oteri, San Diego, CA (US); Dawei Zhang, Saratoga, CA (US); Chunhai Yao, Beijing (CN); Yushu Zhang, Beijing (CN); Ruoheng Liu, San Diego, CA (US); Haitong Sun, Cupertino, CA (US); Seyed Ali Akbar Fakoorian, San Diego, CA (US)

(21) Appl. No.: 18/859,197

(22) PCT Filed: Apr. 27, 2023
(86) PCT No.: PCT/US2023/066285

§ 371 Date: Oct. 23, 2024

Related U.S. Application Data
(60) Provisional application No. 63/363,723, filed on Apr. 28, 2022.

(51) Int. Cl. H04W 72/1273; H04L 1/00; H04L 1/1812; H04L 1/1829; H04L 5/00; H04W 72/044; H04W 72/231

(52) U.S. Cl. CPC H04W 72/1273; H04L 1/0003; H04L 1/1812; H04L 1/1854; H04L 5/0055; H04W 72/044; H04W 72/231

(57) ABSTRACT

System and methods for using ultra compact downlink control information (DCI) in conjunction with one or more scheduling physical downlink shared channels (PDSCHs) are disclosed herein. A base station may transmit, to a user equipment (UE), an ultra compact DCI that schedules the one or more scheduling PDSCHs. The one or more scheduling PDSCHs may schedule a data PDSCH or physical uplink shared channel (PUSCH) that is to be used for user/application layer data transmission. The ultra compact DCI and/or the one or more scheduling PDSCHs may be as configured by a system information block (SIB). The ultra compact DCI and/or the one or more scheduling PDSCHs may schedule a physical uplink control channel (PUCCH) used for hybrid automatic repeat request acknowledgement (HARQ-ACK) signaling relative to the one or more scheduling PDSCHs. Aspects regarding the use of these systems and methods in non-terrestrial network (NTN) contexts are considered.

### TECHNICAL FIELD

This application relates generally to wireless communication systems, including wireless communication systems using ultra compact DCI and/or one or more scheduling physical downlink shared channel (PDSCH) for scheduling PDSCHs and/or scheduling physical uplink shared channels (PUSCHs) for data transmission (e.g., user/application data transmission).

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an NTN architecture of a wireless communication system, according to an embodiment.

FIG. 2 illustrates an NTN architecture of a wireless communication system, according to an embodiment.

FIG. 3 illustrates a diagram for a dynamic resource grant procedure for DL data transmission, according to an embodiment.

FIG. 4 illustrates a diagram for a dynamic resource grant procedure for UL data transmission, according to an embodiment.

FIG. 5 illustrates a diagram for a dynamic resource grant procedure for DL data transmission using ultra compact DCI and one or more scheduling PDSCHs, according to an embodiment.

FIG. 6 illustrates a diagram for a dynamic resource grant procedure for DL data transmission using ultra compact DCI and one or more scheduling PDSCHs, according to an embodiment.

FIG. 7 illustrates a diagram for a dynamic resource grant procedure for UL data transmission using ultra compact DCI and one or more scheduling PDSCHs, according to an embodiment.

FIG. 8 illustrates a diagram for a dynamic resource grant procedure for UL data transmission using ultra compact DCI and one or more scheduling PDSCHs, according to an embodiment.

FIG. 9 illustrates a method of a UE, according to an embodiment.

FIG. 10 illustrates a method of a base station, according to an embodiment.

FIG. 11 illustrates a diagram for dynamic resource grant procedure for DL data transmission, according to an embodiment.

FIG. 12 illustrates a method of a UE, according to an embodiment.

FIG. 13 illustrates a method of a base station, according to an embodiment.

FIG. 14 illustrates a method of a UE, according to an embodiment.

FIG. 15 illustrates a method of a base station, according to an embodiment.

FIG. 16 illustrates an example architecture of a wireless communication system, according to embodiments disclosed herein.

FIG. 17 illustrates a system for performing signaling between a wireless device and a RAN device connected to a core network of a CN device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

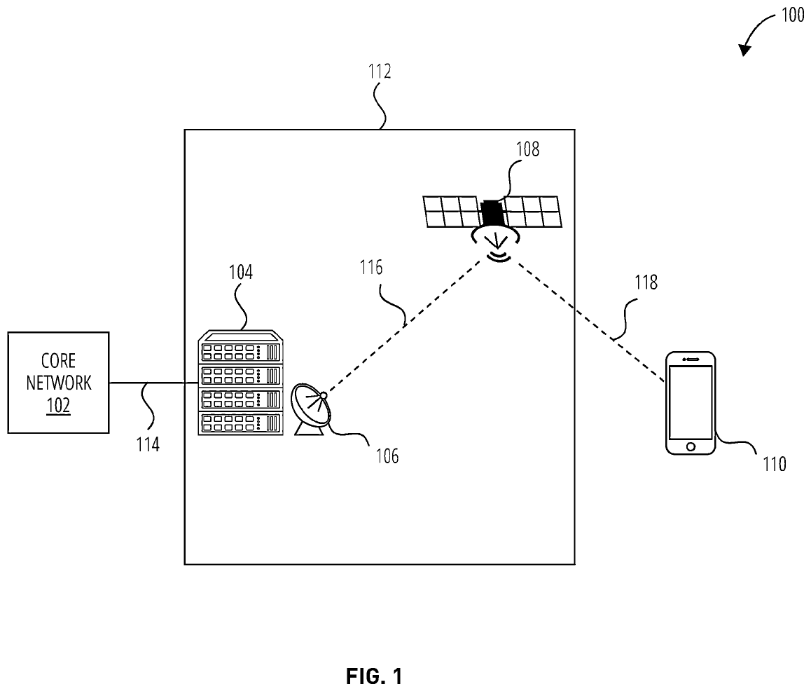

FIG. 1 illustrates a non-terrestrial network (NTN) architecture 100 of a wireless communication system, according to an embodiment. The NTN architecture 100 includes a core network (CN) 102, a terrestrial base station 104, a satellite gateway 106, a satellite 108, and a UE 110. The terrestrial base station 104, the satellite gateway 106, and the satellite 108 may be included in a RAN 112.

In some embodiments, the RAN 112 includes E-UTRAN, the CN 102 includes an EPC, and the terrestrial base station 104 includes an eNB. In these cases, the CN link 114 connecting the CN 102 and the terrestrial base station 104 may include an S1 interface.

In some embodiments, RAN 112 includes NG-RAN, the CN 102 includes a 5GC, and the terrestrial base station 104 includes a gNB or a next generation eNB (ng-eNB). In such cases, the CN link 114 connecting the CN 102 and the terrestrial base station 104 may include an NG interface.

The NTN architecture 100 illustrates a “bent-pipe” or “transparent” satellite based architecture. In such bent-pipe systems, the terrestrial base station 104 uses the satellite gateway 106 to communicate with the satellite 108 over a feeder link 116. The satellite 108 may be equipped with one or more antennas capable of broadcasting a cell according to the RAN 112, and the UE 110 may be equipped with one or more antennas (e.g., a moving parabolic antenna, an omni-directional phased-array antenna, etc.) capable of communicating with the satellite 108 via a Uu interface on that cell (such communications may be said to use the illustrated service link 118). A payload sited on the satellite 108 then transparently forwards data between the satellite gateway 106 and the UE 110 using the feeder link 116 between the satellite gateway 106 and the satellite 108 and the service link 118 between the satellite 108 and the UE 110. The payload may perform RF conversion and/or amplification in both uplink (UL) and downlink (DL) to enable this communication.

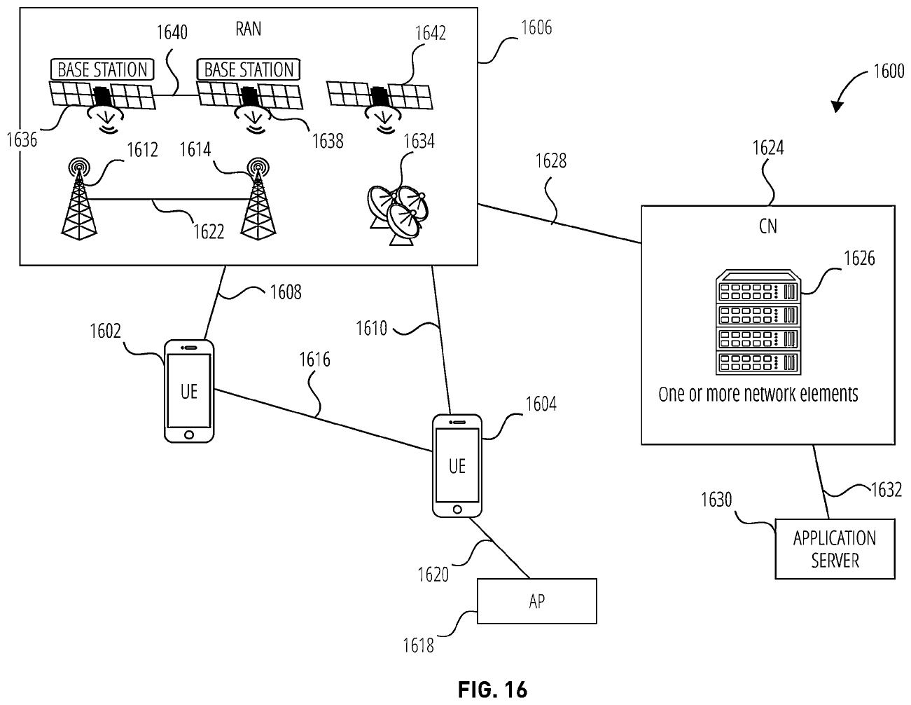

In the embodiment shown in FIG. 1, the terrestrial base station 104 is illustrated without the capability of terrestrial wireless communication directly with a UE. However, it is contemplated that in other embodiments, such a terrestrial base station using the satellite gateway 106 to communicate with the satellite 108 could (also) have this functionality (i.e., as in the terrestrial base station 1612 and the terrestrial base station 1614 of FIG. 16, to be described below).

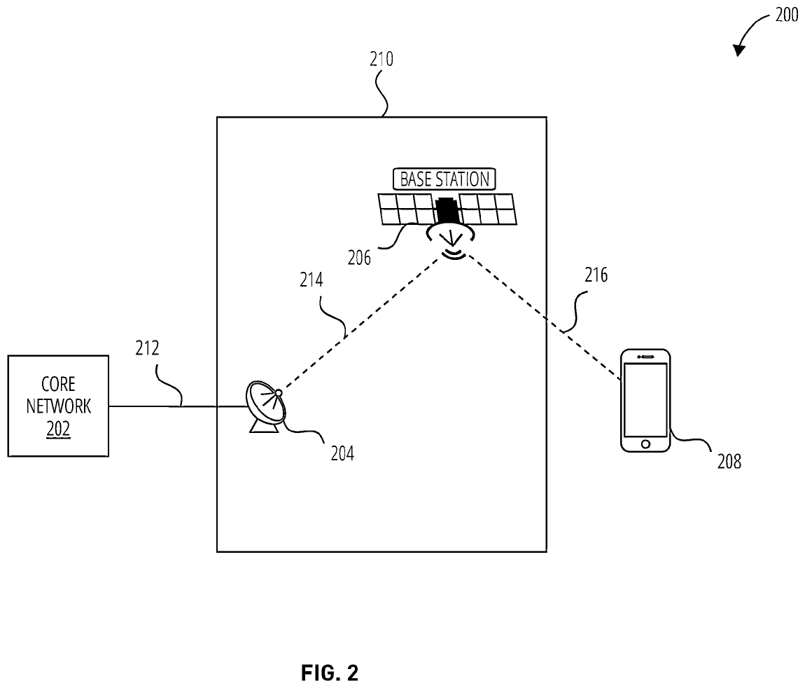

FIG. 2 illustrates an NTN architecture 200 of a wireless communication system, according to an embodiment. The NTN architecture 200 includes a CN 202, a satellite gateway 204, a satellite base station 206, and a UE 208. The satellite gateway 204 and the satellite base station 206 may be included in the RAN 210.

In some embodiments, the RAN 210 includes E-UTRAN and the CN 202 includes an EPC. In these cases, the CN link 212 connecting the CN 202 and the satellite gateway 204 may include an S1 interface.

In some embodiments, RAN 210 includes NG-RAN and the CN 202 includes a 5GC. In such cases, the CN link 212 connecting the CN 202 and the satellite gateway 204 may include an NG interface.

The NTN architecture 200 implements a “regenerative” satellite based architecture. In such regenerative systems, the functionalities of a base station are sited on the satellite base station 206, and the communications between these base station functions and the CN 202 occur through a forwarding of interface(s) (e.g., a S1 interface and/or an NG interface) found on the CN link 212 through the satellite gateway 204 and a feeder link 214 to the satellite base station 206. The satellite base station 206 may be equipped with one or more antennas capable of broadcasting a cell according to the RAN 210, and the UE 208 may be equipped with one or more antennas (e.g., a moving parabolic antenna, an omni-directional phased-array antenna, etc.) capable of communicating with the satellite base station 206 via a Uu interface on that cell (such communications may be said to use the illustrated service link 216). A payload sited on the satellite base station 206 then forwards data between the satellite gateway 204 and the UE 208 using the feeder link 214 between the satellite gateway 204 and the satellite base station 206 and the service link 216 between the satellite base station 206 and the UE 208. The payload may perform RF conversion and/or amplification in both uplink (UL) and downlink (DL) to enable this communication, as well as implement the functionalities of the base station (e.g., as an eNB, ng-eNB or a gNB, as corresponding to the type of the RAN 210) as these have been sited on the satellite base station 206.

In embodiments of NTN architectures comprising NG-RAN that also use integrated access and backhaul (IAB), it is possible that a gNB control unit functionality (CU) could be sited terrestrially and may use a satellite gateway to communicate with a satellite that hosts a corresponding gNB donor unit functionality (DU), with the F1 interface(s) between the CU and the DU underpinned by the feeder link 214. In such cases, the CU and the DU may each be understood to be part of the NG-RAN.

Characteristic differences of NTNs versus terrestrial networks may include relatively larger propagation delays and the potential for movement of the satellite relative to a current position of a UE. Accordingly, improvements to wireless communications systems may be intended to help alleviate undesirable effects stemming from these circumstances. Such improvements may respond to the need to improve various services provided to a UE by an NTN (e.g., voice service, data service) in view of real-world characteristics of NTN performance (e.g., as opposed to an idealized case). Such improvements to NTN use may be arranged to account for relevant regulatory restrictions, such as (for example) limitations on power flux density (PFD) at surface/ground level as established by the International Telecommunications Union (ITU). It will be understood that in some circumstances, such improvements may be achieved (at least in part) via a particular use of one or more physical radio channels in a way that helps to alleviate these and other NTN-related issues.

In some instances, pairing of the L-band (e.g., 1,610 megahertz (MHz) to 1,618.775 MHz) and the S-band (e.g., 2,483.5 MHz to 2,500 MHz) may be considered. For example, it may be that the L-band may be used for UL between a satellite and a UE while the S-band may be used for DL between the satellite and the UE.

A PFD limitation on the use of this S-band may be applicable according to various regulations. For example, as applicable in a mobile-satellite service context in in the 2,483.5 MHz to 2,500 MHz range, a PFD limitation may be expressed in terms of the PFD calculation factors P (expressed in dB (W/m²) per MHz or per X kilohertz (kHz)) and r (expressed in dB/degree). Values for these PFD calculation factors may depend on whether a satellite is a GSO satellite or a non-GSO satellite. The appropriate values for the PFD calculation factors may be applied in a defined way relative to an angle of arrival above the horizontal plane (relative to a location on the earth's surface) δ (in degrees) to arrive at the PFD limitation.

For example, a satellite in a geostationary orbit (GSO) may correspond to PFD calculation factors P=−146 dB (W/m²) in 4 kHz or −128 dB (W/m²) in 1 MHz and r=0.5 dB/degree, while a satellite in a non-GSO may correspond to parameters P=−144 dB (W/m²) in 4 kHz or −126 dB (W/m²) in 1 MHz and r=0.65 dB/degree. In some regions, a satellite in a non-GSO may instead use P=−142.5 dB (W/m²) in 4 kHz and −124.5 dB (W/m²) in 1 MHz.

Then, using the appropriate PFD calculation factors P and r according to the applicable satellite information, a PFD limitation relative to the satellite can be calculated according to the applicable δ between a UE location and the satellite using:

$$PFD = P , for 0 ° \leq δ \leq 5 ° ;$$

$$PFD = P + r ( δ - 5 ) , for 5 ° \leq δ \leq 25 ° ; and$$

$$PFD = P + 20 r , for 25 ° \leq δ \leq 90 ° .$$

Within such PFD constraints as calculated, it may be that DL transmission power (or effective isotropic radiated power (EIRP)) in the 2,483.5 MHz to 2,500 MHz range cannot be large enough to cover the entire geographic cell of the satellite with strong coverage.

Accordingly, the use of embodiments described herein may, for example, enhance the DL coverage experienced by a UE within the cell of the satellite when such circumstances as described here are applicable.

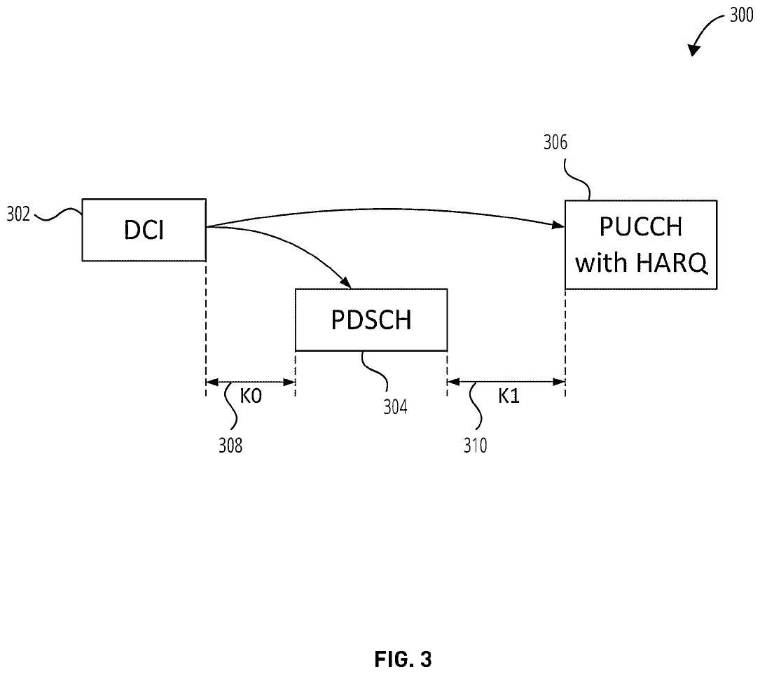

FIG. 3 illustrates a diagram 300 for a dynamic resource grant procedure for DL data transmission, according to an embodiment. The diagram 300 illustrates that the downlink control information (DCI) 302 is sent from a base station to a UE. The DCI 302 may be carried in a physical downlink control channel (PDCCH). The DCI 302 may be, for example, of DCI format 1_0, 1_1, or 1_2.

The DCI 302 may indicate to the UE that the network has allocated the PDSCH 304 with DL data resources for the UE (e.g., the network has scheduled the use of the PDSCH 304 for the UE), and may further indicate to the UE the time and frequency location of the PDSCH 304. As illustrated, a minimum offset K0 308 between the DCI 302 scheduling the PDSCH 304 and the PDSCH 304 itself may be maintained by the network.

The DCI 302 may also indicate to the UE that the network has allocated the PUCCH 306 to be used by the UE for any hybrid automatic repeat request acknowledgement (HARQ-ACK) signaling related to the receipt and attempted decoding of the PDSCH 304 by the UE (e.g., the network has scheduled the use of the PUCCH 306 by the UE). As illustrated, a minimum offset K1 310 between the PDSCH 304 and the PUCCH 306 may be maintained by the network.

The UE may accordingly attempt to receive and decode the PDSCH 304 at the time/frequency resources that were indicated for the PDSCH 304 in the DCI 302. The UE may then transmit HARQ-ACK signaling corresponding to the result on the PUCCH 306. For example, if the receipt and decoding of the PDSCH 304 by the UE was successful, the HARQ-ACK signaling on the PUCCH 306 may comprise an acknowledgment (ACK). If the receipt and/or decoding of the PDSCH 304 was unsuccessful, the HARQ-ACK signaling on the PUCCH 306 may instead comprise a negative acknowledgement (NACK).

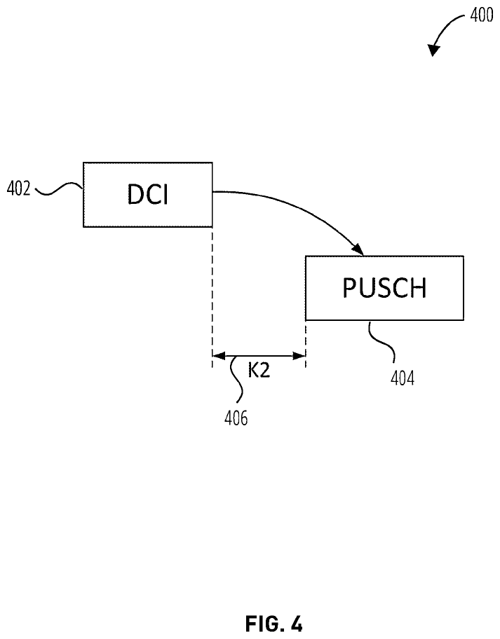

FIG. 4 illustrates a diagram 400 for a dynamic resource grant procedure for UL data transmission, according to an embodiment. The diagram 400 illustrates that the DCI 402 is sent from a base station to a UE. The DCI 402 may be carried in a PDCCH. The DCI 402 may be, for example, of DCI format 0_0, 0_1, or 0_2.

The DCI 402 may indicate to the UE that the network has allocated the PUSCH 404 for use by the UE for transmitting UL data (e.g., the network has scheduled the use of the PUSCH 404 for the UE), and may further indicate to the UE the time and frequency location of the PUSCH 404. As illustrated, a minimum offset K2 406 between the DCI 402 scheduling the PUSCH 404 and the PUSCH 404 itself may be maintained by the network.

The UE may accordingly transmit data on the PUSCH 404 at the time/frequency resources that were indicated for the PUSCH 404 in the DCI 402.

The procedures of FIG. 3 and FIG. 4 may be successfully used in certain cases (e.g., cases involving fully terrestrial networks) where aspects of the behavior of and/or relationship between a base station and a UE are as may be implicitly assumed in those scenarios. However, it has been recognized that in various circumstances, modifications to the procedures illustrated in (and described in relation to) FIG. 3 and FIG. 4 may be beneficial.

For example, in order to address NTN-related issues of additional signaling propagation time and/or distance, and/or of PFD limitations, it has been determined that PDSCH coverage as provided by a satellite of an NTN may be improved by using (a relatively large number of) PDSCH repetitions.

Further, it has been recognized that in the NTN context, PDCCH transmissions (e.g., for DCI, as described herein) may represent a bottleneck in various circumstances. For example, in the case where repeated PDCCHs are not configured for use in an NTN network, a (accordingly single) PDCCH may be more likely to be missed in the NTN context than in another context (e.g., than in a fully terrestrial context). Further, the use of PDCCH repetitions in an NTN context (in an attempt to reduce the chance that PDCCH signaling is altogether missed) may have an outsized negative impact on network throughput overall in some cases (e.g., due to the relatively increased signaling propagation time for the PDCCHs in the NTN context).

Accordingly, it has been recognized that by simplifying DCI use, the impact(s) felt from these PDCCH-related aspects may be reduced. DCI that are structured and/or used according to such a simplified use may be referred to herein as “ultra compact DCI.”

In some embodiments, this simplification may occur via the use of a DCI format for the ultra compact DCI that results in an overall reduced payload size for the ultra compact DCI as compared to payload sizes for DCI according to other DCI formats under the same parameters/circumstances. This may be accomplished in some embodiments by omitting one or more fields from the ultra compact DCI that would otherwise be present in the DCI of the other DCI formats. In some wireless communications networks, such as those that implement LTE RAT and/or NR RAT, it may be that such ultra compact DCI may accordingly have a reduced payload size as compared to a “compact DCI” (e.g., DCI of format 1_2 and/or 0_2) that are known to those networks.

In some embodiments, such a simplification may (alternatively or additionally) occur through the use of fixed values for one or more fields within the ultra compact DCI (which may aid in speeding and/or simplifying the decoding of the ultra compact DCI at the UE). In some of these embodiments, it may be that a payload size of an ultra compact DCI is accordingly not necessarily smaller than a payload size of a DCI of another DCI format known/used in the relevant wireless communication system.

It is noted that in some embodiments, a DCI format for an ultra compact DCI may define for fields beyond those provided for in other DCI formats known to/defined for the wireless communication system. Accordingly, in a subset of such embodiments, it is possible that an ultra compact DCI has a larger payload size than a payload size of a DCI of another DCI format known/used in the relevant wireless communication system (due to these additional fields).

Further, embodiments herein may provide at least some scheduling information for a PDSCH or PUSCH used for data transmission in one or more intervening PDSCHs that occur between the ultra compact DCI and the PDSCH/PUSCH for data transmission (rather than siting this information within the ultra compact DCI). These one or more intervening PDSCHs may be referred to herein as “scheduling PDSCHs.” By using one or more such scheduling PDSCHs to transport scheduling information for the PDSCH/PUSCH for data transmission between the base station and the UE, the payload size of the ultra compact DCI may be accordingly reduced. Herein, a PDSCH for data transmission may be referred to as a “data PDSCH” in order to differentiate it from any scheduling PDSCHs under discussion.

As will be described, in some embodiments, an ultra compact DCI and/or scheduling PDSCHs may further include scheduling information for a PUCCH that may be used by the UE to provide HARQ-ACK signaling to the base station relative to the scheduling PDSCHs. In some embodiments, this PUCCH occurs between the scheduling PDSCHs and the data PDSCH/the PUSCH that is used for data transmission. In some embodiments, this PUCCH may occur after the scheduling PDSCHs and the data PDSCH/the PUSCH that is used for data transmission.

Finally, it may be that the one or more scheduling PDSCHs comprise PDSCH repetitions (and this may be so even in cases where, for example, PDCCH repetition for the ultra compact DCI is not available and/or is not used), thereby increasing the chance of successful reception and decoding at the UE of the attendant scheduling information for the data PDSCH/PUSCH/PUCCH for HARQ (as the case may be).

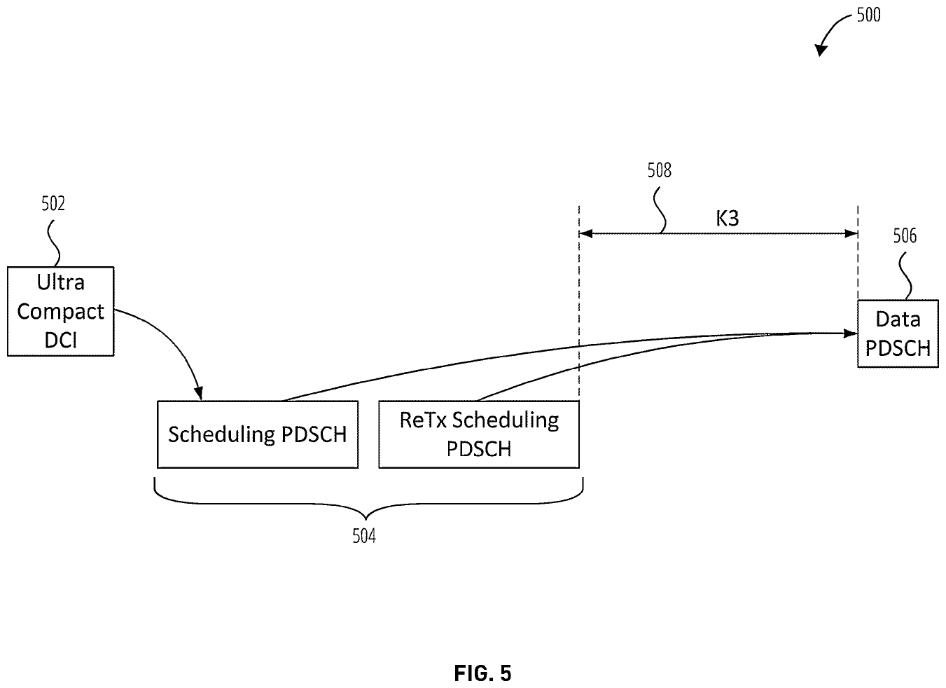

FIG. 5 illustrates a diagram 500 for a dynamic resource grant procedure for DL data transmission using ultra compact DCI and one or more scheduling PDSCHs, according to an embodiment. More specifically, the diagram 500 illustrates the use of an ultra compact DCI 502 and one or more scheduling PDSCHs 504 to schedule a data PDSCH 506 for the DL data transmission.

The diagram 500 illustrates that the ultra compact DCI 502 is transmitted by the base station and received at the UE. The ultra compact DCI 502 provides the UE with sufficient information such that the UE is made aware of the time and frequency location(s) of the one or more scheduling PDSCHs 504 (e.g., the ultra compact DCI 502 schedules the one or more scheduling PDSCHs 504).

The one or more scheduling PDSCHs 504 are then transmitted by the base station as scheduled and received at the UE. The one or more scheduling PDSCHs 504 may include one or more medium access control control elements (MAC CEs) that include scheduling information for the data PDSCH 506. The one or more scheduling PDSCHs 504 accordingly provide the UE (e.g., in the MAC CE(s)) with sufficient information such that the UE is made aware of the time and frequency location of the data PDSCH 506 (e.g., the one or more scheduling PDSCHs 504 schedule the data PDSCH 506).

In some embodiments, the one or more scheduling PDSCHs 504 comprises PDSCH repetitions. For example, in the case that the one or more scheduling PDSCHs 504 includes at least two PDSCHs, each of these two PDSCHs may be the same. In such cases, each of the one or more scheduling PDSCHs 504 would have, for example, a same MAC CE having scheduling information for the data PDSCH 506. The use of such repetitions may provide the UE with additional reception opportunities for this data, thereby improving the probability that the UE will successfully receive and/or decode this data.

The data PDSCH 506 is then transmitted by the base station as scheduled and is received at the UE. The data PDSCH 506 may include, for example, user plane (UP) data (e.g., application layer data for an application operating on the UE).

As illustrated, a minimum offset K3 508 between the last of the one or more scheduling PDSCHs 504 and the data PDSCH 506 may be maintained by the network. In other words, the ultra compact DCI 502 may schedule the one or more scheduling PDSCHs 504, and the one or more scheduling PDSCHs 504 may schedule the data PDSCH 506, such that a minimum offset K3 508 is maintained.

The base station may transmit a system information block (SIB) that includes configuration information for the ultra compact DCI 502 and/or for the one or more scheduling PDSCHs 504. The configuration information for the ultra compact DCI 502 as found in the SIB may be used by the UE to locate the ultra compact DCI 502.

Further, the configuration information for the one or more scheduling PDSCHs 504 as found in the SIB may further be used to locate the one or more scheduling PDSCHs 504 (in other words, the ultra compact DCI 502 may schedule the one or more scheduling PDSCHs 504 in light of/with the background assumption of any configuration for the one or more scheduling PDSCHs 504 provided in the SIB). In some cases, the configuration information for the one or more scheduling PDSCHs 504 in the SIB may relate the time and/or frequency position(s) of any of the one or more scheduling PDSCHs 504 relative to a received ultra compact DCI 502.

This SIB may be transmitted to the UE of the dynamic resource grant procedure of FIG. 5 by the base station of the dynamic resource grant procedure of FIG. 5 (e.g., that transmits the ultra compact DCI 502). Alternatively, the SIB may be transmitted to the UE of FIG. 5 by another base station.

In some cases, after receiving the data PDSCH 506, the UE may reply to the base station with HARQ-ACK signaling on a PUCCH (not illustrated in FIG. 5). For example, if the receipt and decoding of the data PDSCH 506 by the UE was successful, the HARQ-ACK signaling may comprise an ACK. If the receipt and/or decoding of the data PDSCH 506 was unsuccessful, the HARQ-ACK signaling may instead comprise a NACK.

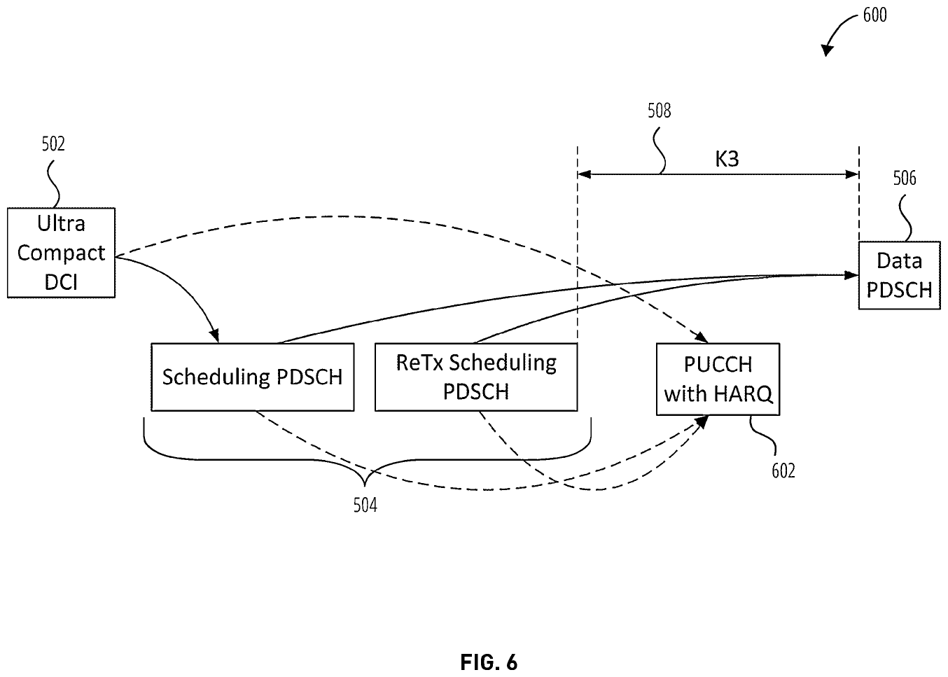

FIG. 6 illustrates a diagram 600 for a dynamic resource grant procedure for DL data transmission using ultra compact DCI and one or more scheduling PDSCHs, according to an embodiment. The diagram 600 is an expansion of the diagram 500 as described in relation to FIG. 5. Accordingly, the diagram 600 illustrates the use of the ultra compact DCI 502, the one or more scheduling PDSCHs 504, the data PDSCH 506, and the offset K3 508 as these were described in relation to the diagram 500 of FIG. 5. In addition to these elements from the diagram 500 of FIG. 5, the diagram 600 of FIG. 6 additionally illustrates the scheduling and use of the PUCCH 602 having HARQ-ACK signaling.

The PUCCH 602 may be used to provide HARQ-ACK signaling from the UE to the base station that indicates whether the UE was able to receive and decode the information provided by the one or more scheduling PDSCHs 504. If the receipt and decoding of the scheduling information for the data PDSCH 506 from the one or more scheduling PDSCHs 504 by the UE was successful, the HARQ-ACK signaling in the PUCCH 602 may comprise an ACK. If the receipt and/or decoding of the scheduling information for the data PDSCH 506 from the one or more scheduling PDSCHs 504 by the UE was unsuccessful, the HARQ-ACK signaling in the PUCCH 602 may instead comprise a NACK. In the event of a NACK (or in the event that any expected PUCCH 602 does not arrive at the base station at all), the base station may determine that the UE may not in any event use the data PDSCH 506 and may accordingly cancel its transmission of the data PDSCH 506 in order to save network resources.

As illustrated in the diagram 600 of FIG. 6, either of the ultra compact DCI 502 and the one or more scheduling PDSCHs 504 (or any ones of these in any combination) provides the UE with sufficient information such that the UE is made aware of the time and frequency location(s) of the PUCCH 602 (e.g., the ultra compact DCI 502 and/or the some/all of the one or more scheduling PDSCHs 504 schedule the PUCCH 602).

Alternatively (or additionally), an SIB received at the UE may provide configuration information for the PUCCH 602, including (but not limited to) providing information regarding the time and/or frequency location of the PUCCH 602. In such circumstances, the configuration information for the PUCCH 602 in the SIB may relate the time and/or frequency position(s) of the PUCCH 602 relative to a received ultra compact DCI 502 and/or any of the one or more scheduling PDSCHs 504.

The diagram 600 of FIG. 6 illustrates the PUCCH 602 in between the one or more scheduling PDSCHs 504 and the data PDSCH 506. It is noted that in alternative embodiments, a PUCCH 602 as described herein might instead be positioned after the data PDSCH 506.

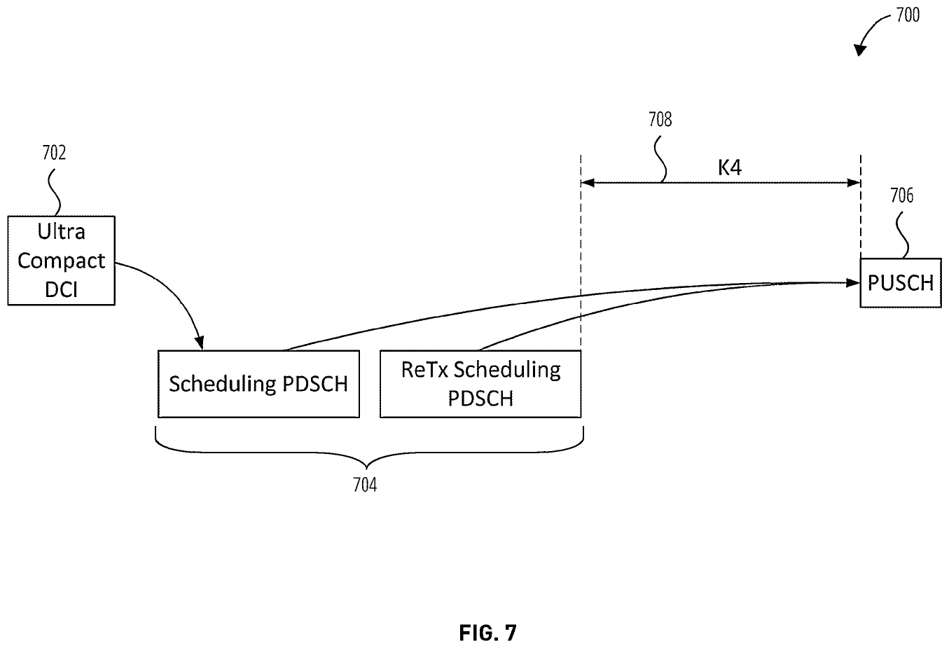

FIG. 7 illustrates a diagram 700 for a dynamic resource grant procedure for UL data transmission using ultra compact DCI and one or more scheduling PDSCHs, according to an embodiment. More specifically, the diagram 700 illustrates the use of an ultra compact DCI 702 and one or more scheduling PDSCHs 704 to schedule a PUSCH 706 for the UL data transmission.

The diagram 700 illustrates that the ultra compact DCI 702 is transmitted by the base station and received at the UE. The ultra compact DCI 702 provides the UE with sufficient information such that the UE is made aware of the time and frequency location(s) of the one or more scheduling PDSCHs 704 (e.g., the ultra compact DCI 702 schedules the one or more scheduling PDSCHs 704).

The one or more scheduling PDSCHs 704 are then transmitted by the base station as scheduled and received at the UE. The one or more scheduling PDSCHs 704 may include one or more medium access control control elements (MAC CEs) that include scheduling information for the PUSCH 706. The one or more scheduling PDSCHs 704 accordingly provide the UE (e.g., in the MAC CE(s)) with sufficient information such that the UE is made aware of the time and frequency location of the PUSCH 706 (e.g., the one or more scheduling PDSCHs 704 schedule the PUSCH 706).

In some embodiments, the one or more scheduling PDSCHs 704 comprises PDSCH repetitions. For example, in the case that the one or more scheduling PDSCHs 704 includes at least two PDSCHs, each of these two PDSCHs may be the same. In such cases, each of the one or more scheduling PDSCHs 704 would have, for example, a same MAC CE having scheduling information for the PUSCH 706. The use of such repetitions may provide the UE with additional reception opportunities for this data, thereby improving the probability that the UE will successfully receive and/or decode this data.

The PUSCH 706 is then transmitted by the UE as scheduled. The PUSCH 706 may include, for example, user plane (UP) data (e.g., application layer data for an application operating on the UE).

As illustrated, a minimum offset K4 708 between the last of the one or more scheduling PDSCHs 704 and the PUSCH 706 may be maintained by the network. In other words, the ultra compact DCI 702 may schedule the one or more scheduling PDSCHs 704, and the one or more scheduling PDSCHs 704 may schedule the PUSCH 706, such that a minimum offset K4 708 is maintained.

The base station may transmit a system information block (SIB) that includes configuration information for the ultra compact DCI 702 and/or for the one or more scheduling PDSCHs 704. The configuration information for the ultra compact DCI 702 as found in the SIB may be used by the UE to locate the ultra compact DCI 702.

Further, the configuration information for the one or more scheduling PDSCHs 704 as found in the SIB may further be used to locate the one or more scheduling PDSCHs 704 (in other words, the ultra compact DCI 702 may schedule the one or more scheduling PDSCHs 704 in light of/with the background assumption of any configuration for the one or more scheduling PDSCHs 704 provided in the SIB). In some cases, the configuration information for the one or more scheduling PDSCHs 704 in the SIB may relate the time and/or frequency position(s) of any of the one or more scheduling PDSCHs 704 relative to a received ultra compact DCI 702.

This SIB may be transmitted to the UE of the dynamic resource grant procedure of FIG. 7 by the base station of the dynamic resource grant procedure of FIG. 7 (e.g., that transmits the ultra compact DCI 702). Alternatively, the SIB may be transmitted to the UE of FIG. 7 by another base station.

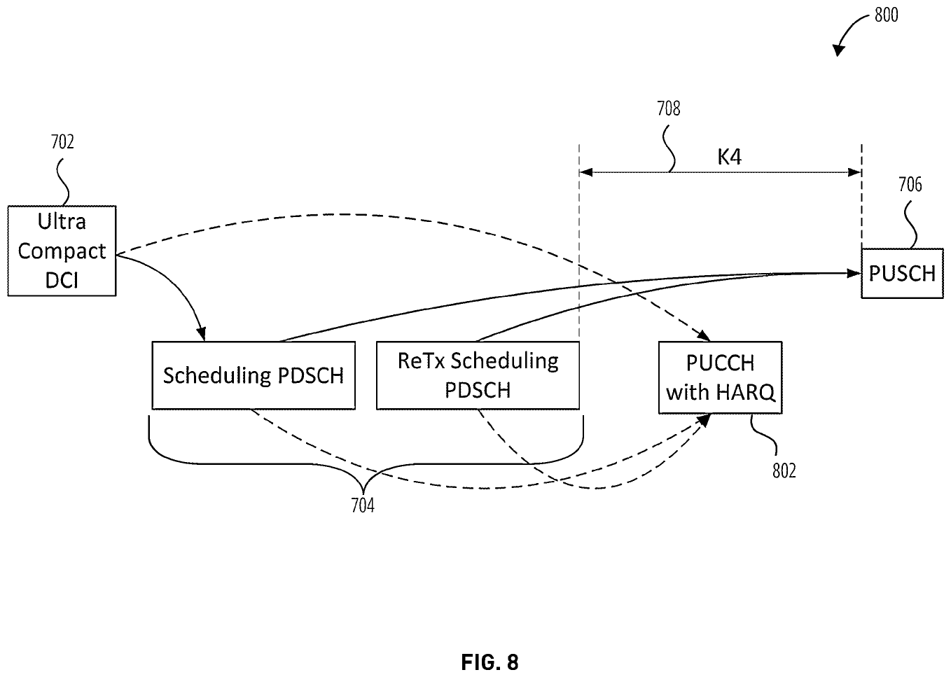

FIG. 8 illustrates a diagram 800 for a dynamic resource grant procedure for UL data transmission using ultra compact DCI and one or more scheduling PDSCHs, according to an embodiment. The diagram 800 is an expansion of the diagram 700 as described in relation to the diagram 700 of FIG. 7. Accordingly, the diagram 800 illustrates the use of the ultra compact DCI 702, the one or more scheduling PDSCHs 704, the PUSCH 706, and the offset K4 708 as these were described in relation to the diagram 700 of FIG. 7. In addition to these elements from the diagram 700 of FIG. 7, the diagram 800 of FIG. 8 additionally illustrates the scheduling and use of the PUCCH 802 having HARQ-ACK signaling.

The PUCCH 802 may be used to provide HARQ-ACK signaling from the UE to the base station that indicates whether the UE was able to receive and decode the information provided by the one or more scheduling PDSCHs 704. If the receipt and decoding of the scheduling information for the PUSCH 706 from the one or more scheduling PDSCHs 704 by the UE was successful, the HARQ-ACK signaling in the PUCCH 802 may comprise an ACK. If the receipt and/or decoding of the scheduling information for the PUSCH 706 from the one or more scheduling PDSCHs 704 by the UE was unsuccessful, the HARQ-ACK signaling in the PUCCH 802 may instead comprise a NACK. In the event of a NACK (or in the event that any expected PUCCH 802 does not arrive at the base station at all), the base station may determine that the UE may not in any event use the PUSCH 706 and may accordingly cancel its scheduled reception attempt for the PUSCH 706 in order to save network resources.

As illustrated in the diagram 800 of FIG. 8, either of the ultra compact DCI 702 and the one or more scheduling PDSCHs 704 (or any ones of these in any combination) provides the UE with sufficient information such that the UE is made aware of the time and frequency location(s) of the PUCCH 802 (e.g., the ultra compact DCI 702 and/or the some/all of the one or more scheduling PDSCHs 704 schedule the PUCCH 802).

Alternatively (or additionally), an SIB received at the UE may provide configuration information for the PUCCH 802, including (but not limited to) providing information regarding the time and/or frequency location of the PUCCH 802. In such circumstances, the configuration information for the PUCCH 802 in the SIB may relate the time and/or frequency position(s) of the PUCCH 802 relative to a received ultra compact DCI 702 and/or any of the one or more scheduling PDSCHs 704.

The diagram 800 of FIG. 8 illustrates the PUCCH 802 in between the one or more scheduling PDSCHs 704 and the PUSCH 706. It is noted that in alternative embodiments, a PUCCH 802 as described herein might instead be positioned after the PUSCH 706.

### SIB Designs

SIBs having configuration information for an ultra compact DCI and/or one or more scheduling PDSCHs are now discussed. As described herein, an SIB may be received at a UE preliminary to the receipt and/or decoding of, for example, an ultra compact DCI and/or one or more PDSCHs (e.g., corresponding to configuration information in the SIB).

Various formats for SIBs having configuration information for an ultra compact DCI and/or one or more scheduling PDSCH are contemplated. In some embodiments, it may be that an SIB1 as understood in definitions for some wireless communications systems is used to communicate configuration information for an ultra compact DCI and/or one or more scheduling PDSCHs. In some embodiments, a NTN-specific SIB format may be used to communicate configuration information for an ultra compact DCI and/or one or more scheduling PDSCHs. Such an NTN-specific SIB format may be designated as an SIBx in definitions for some types of wireless communications systems. In some embodiments, a new SIB format (e.g., other than an SIB1 or an SIBx and that is new within a wireless communications system) may be used.

An SIB having configuration information for an ultra compact DCI and/or one or more scheduling PDSCHs may be used as described herein in either the UL transmission case or the DL transmission case.

An SIB may include an indication of whether the use of one or more scheduling PDSCHs for ultra compact DCI is enabled or not. In such cases, an SIB may also include the configuration information for an ultra compact DCI and/or one or more scheduling PDSCHs in the event that this indication is for the use of one or more scheduling PDSCHs for ultra compact DCI.

Configuration information for an ultra compact DCI as found in an SIB may include a resource mapping rule for identifying resources used by one or more scheduling PDSCHs relative to resources used by the ultra compact DCI. For example, such a mapping rule may provide for a 1:1 mapping scheme that may be used by a UE to determine a time and/or frequency location(s) of one or more scheduling PDSCHs scheduled by an ultra compact DCI relative to the time and/or frequency location of the ultra compact DCI itself. In such embodiments, it may be that there is no need for the ultra compact DCI to make explicit TDRA and/or FDRA indication(s) corresponding to the one or more scheduling PDSCHs.

Configuration information for an ultra compact DCI as found in an SIB may include a number of PDCCH repetitions that carry repetitions of the ultra compact DCI, in the event that PDCCH repetitions will be used to communicate the ultra compact DCI. The SIB may further indicate for the use of intra-slot repetition or inter-slot repetition for these PDCCH repetitions.

Configuration information for an ultra compact DCI as found in an SIB may include an indication of one or more fields that are used in the ultra compact DCI. It may be that one or more fields of an ultra compact DCI as understood by the wireless communications system is optional (e.g., because it is not strictly necessary, because information corresponding to those fields is instead found in the one or more scheduling PDSCHs, and/or because the UE is configured to use a pre-defined value for that field in the event that it is not present). Accordingly, an SIB may include an indication regarding which of these fields is present (or not) in an ultra compact DCI to be sent.

Configuration information for an ultra compact DCI as found in an SIB may include an indication of whether a new data indicator (NDI) field is included in the ultra compact DCI. This may inform the UE whether or not to operate according to/provide for the use of the NDI field relative to the ultra compact DCI.

An SIB having configuration information for an ultra compact DCI and/or one or more scheduling PDSCHs may include numerology information for a PDCCH that carries an ultra compact DCI and/or one or more scheduling PDSCHs. In some cases, it may be that a smaller sub-carrier spacing (SCS) than what is otherwise configured for resources corresponding to/overlapping with those used by the PDCCH of the ultra compact DCI and/or the one or more scheduling PDSCHs within the wireless communications system is used for the PDCCH of the ultra compact DCI and/or the one or more scheduling PDSCHs. For example, in NR, it may be that a PDCCH having an ultra compact DCI and/or one or more scheduling PDSCHs use a 3.75 kilohertz (kHz) SCS and/or a 7.5 kHz SCS, where usually at least a 15 kHz SCS may be used for other channels/transmissions. The use of a relatively smaller SCS in this manner may increase the coverage of the PDCCH of the ultra compact DCI and/or the one or more scheduling PDSCHs.

Configuration information for one or more scheduling PDSCHs as found in an SIB may include modulation and coding scheme (MCS) information for the one or more scheduling PDSCHs.

Configuration information for one or more scheduling PDSCHs as found in an SIB may include a HARQ process number for the one or more scheduling PDSCHs

Configuration information for one or more scheduling PDSCHs as found in an SIB may include a redundancy version (RV) for the scheduling PDSCHs.

Configuration information for one or more scheduling PDSCHs as found in an SIB may include a number of PDSCH repetitions within the one or more scheduling PDSCHs.

Configuration information for one or more scheduling PDSCHs as found in an SIB may include a maximum number of layers of the one or more scheduling PDSCHs. In some embodiments, it may be that configuration information for a maximum number of layers is present when the maximum number of layers for the one or more scheduling PDSCHs is not 1; otherwise, this information may not be included (and a UE may thereby implicitly understand the maximum number of layers to be 1).

Configuration information for one or more scheduling PDSCHs as found in an SIB may include an aggregation level of the one or more scheduling PDSCHs. In some embodiments, it may be that configuration information for an aggregation level is present when the aggregation level for the one or more scheduling PDSCHs is not 16; otherwise, this information may not be included (and a UE may thereby implicitly understand the aggregation to be a pre-understood value (e.g., 16)).

An SIB having configuration information for an ultra compact DCI and/or one or more scheduling PDSCHs may also include configuration information for a data PDSCH.

Configuration information for a data PDSCH as found in an SIB may include a maximum number of layers of the data PDSCH. In some embodiments, it may be that configuration information for a maximum number of layers is present when the maximum number of layers for the data PDSCH is not 1; otherwise, this information may not be included (and a UE may thereby implicitly understand the maximum number of layers to be 1).

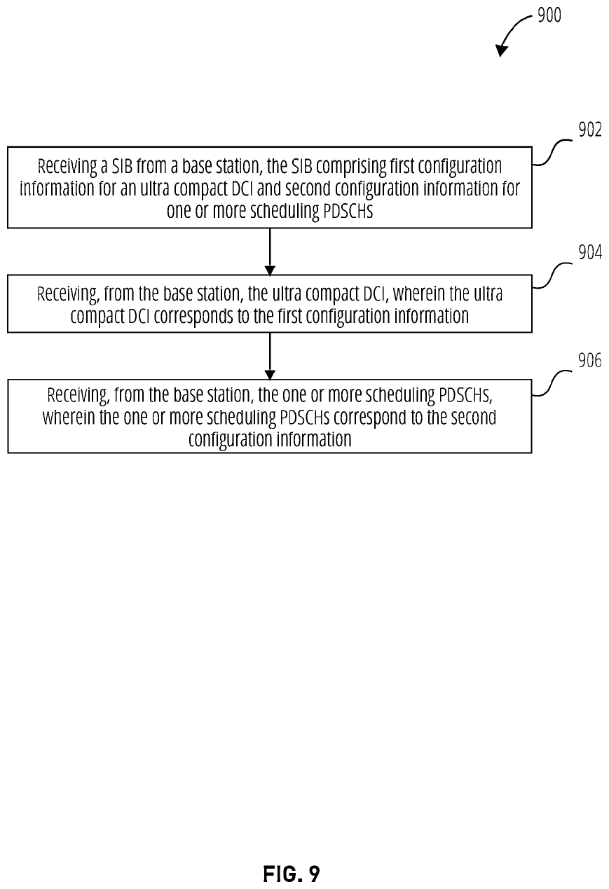

FIG. 9 illustrates a method 900 of a UE, according to an embodiment. The method 900 includes receiving 902 an SIB from a base station, the SIB comprising first configuration information for an ultra compact DCI and second configuration information for one or more scheduling PDSCHs.

The method 900 further includes receiving 904, from the base station, the ultra compact DCI, wherein the ultra compact DCI corresponds to the first configuration information.

The method 900 further includes receiving 906, from the base station, the one or more scheduling PDSCHs, wherein the one or more scheduling PDSCHs correspond to the second configuration information.

In some embodiments of the method 900, the first configuration information for the ultra compact DCI comprises one or more of a resource mapping rule for identifying resources used by the one or more scheduling PDSCHs relative to resources used by the ultra compact DCI; a number of PDCCH repetitions that carry repetitions of the ultra compact DCI; an indication of one or more fields that are used in the ultra compact DCI; and an indication of whether a NDI field is included in the ultra compact DCI.

In some embodiments of the method 900, the SIB further comprises numerology information for a PDCCH that carries the ultra compact DCI.

In some embodiments of the method 900, the second configuration information for the one or more scheduling PDSCHs comprises one or more of MCS information for the one or more scheduling PDSCHs; a HARQ process number for the one or more scheduling PDSCHs; an RV for the scheduling PDSCHs; a number of PDSCH repetitions within the one or more scheduling PDSCHs; a maximum number of layers of the one or more scheduling PDSCHs; and an aggregation level of the one or more scheduling PDSCHs.

Embodiments contemplated herein include an apparatus comprising means to perform one or more elements of the method 900. This apparatus may be, for example, an apparatus of a UE (such as a wireless device 1702 that is a UE, as described herein).

Embodiments contemplated herein include one or more non-transitory computer-readable media comprising instructions to cause an electronic device, upon execution of the instructions by one or more processors of the electronic device, to perform one or more elements of the method 900. This non-transitory computer-readable media may be, for example, a memory of a UE (such as a memory 1706 of a wireless device 1702 that is a UE, as described herein).

Embodiments contemplated herein include an apparatus comprising logic, modules, or circuitry to perform one or more elements of the method 900. This apparatus may be, for example, an apparatus of a UE (such as a wireless device 1702 that is a UE, as described herein).

Embodiments contemplated herein include an apparatus comprising: one or more processors and one or more computer-readable media comprising instructions that, when executed by the one or more processors, cause the one or more processors to perform one or more elements of the method 900. This apparatus may be, for example, an apparatus of a UE (such as a wireless device 1702 that is a UE, as described herein).

Embodiments contemplated herein include a signal as described in or related to one or more elements of the method 900.

Embodiments contemplated herein include a computer program or computer program product comprising instructions, wherein execution of the program by a processor is to cause the processor to carry out one or more elements of the method 900. The processor may be a processor of a UE (such as a processor(s) 1704 of a wireless device 1702 that is a UE, as described herein). These instructions may be, for example, located in the processor and/or on a memory of the UE (such as a memory 1706 of a wireless device 1702 that is a UE, as described herein).

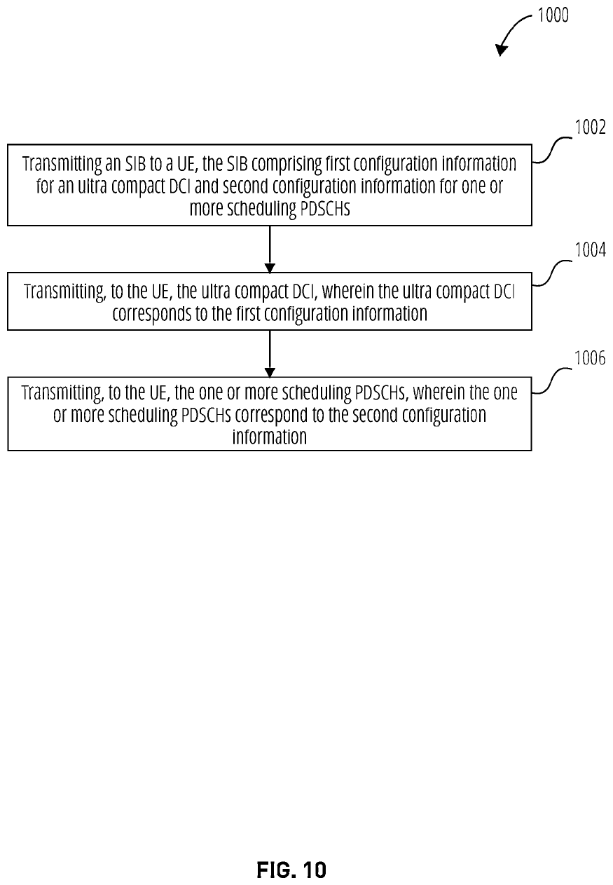

FIG. 10 illustrates a method 1000 of a base station, according to an embodiment. The method 1000 includes transmitting 1002 an SIB to a UE, the SIB comprising first configuration information for an ultra compact DCI and second configuration information for one or more scheduling PDSCHs.

The method 1000 further includes transmitting 1004, to the UE, the ultra compact DCI, wherein the ultra compact DCI corresponds to the first configuration information.

The method 1000 further includes transmitting 1006, to the UE, the one or more scheduling PDSCHs, wherein the one or more scheduling PDSCHs correspond to the second configuration information.

In some embodiments of the method 1000, the first configuration information for the ultra compact DCI comprises one or more of a resource mapping rule for identifying resources used by the one or more scheduling PDSCHs relative to resources used by the ultra compact DCI; a number of PDCCH repetitions that carry repetitions of the ultra compact DCI; an indication of one or more fields that are used in the ultra compact DCI; and an indication of whether a NDI field is included in the ultra compact DCI.

In some embodiments of the method 1000, the SIB further comprises numerology information for a PDCCH that carries the ultra compact DCI.

In some embodiments of the method 1000, the second configuration information for the one or more scheduling PDSCHs comprises one or more of MCS information for the one or more scheduling PDSCHs; a HARQ process number for the one or more scheduling PDSCHs; an RV for the scheduling PDSCHs; a number of PDSCH repetitions within the one or more scheduling PDSCHs; a maximum number of layers of the one or more scheduling PDSCHs; and an aggregation level of the one or more scheduling PDSCHs.

Embodiments contemplated herein include an apparatus comprising means to perform one or more elements of the method 1000. This apparatus may be, for example, an apparatus of a base station (such as a RAN device 1718 that is a base station, as described herein).

Embodiments contemplated herein include one or more non-transitory computer-readable media comprising instructions to cause an electronic device, upon execution of the instructions by one or more processors of the electronic device, to perform one or more elements of the method 1000. This non-transitory computer-readable media may be, for example, a memory of a base station (such as a memory 1722 of a RAN device 1718 that is a base station, as described herein).

Embodiments contemplated herein include an apparatus comprising logic, modules, or circuitry to perform one or more elements of the method 1000. This apparatus may be, for example, an apparatus of a base station (such as a RAN device 1718 that is a base station, as described herein).

Embodiments contemplated herein include an apparatus comprising: one or more processors and one or more computer-readable media comprising instructions that, when executed by the one or more processors, cause the one or more processors to perform one or more elements of the method 1000. This apparatus may be, for example, an apparatus of a base station (such as a RAN device 1718 that is a base station, as described herein).

Embodiments contemplated herein include a signal as described in or related to one or more elements of the method 1000.

Embodiments contemplated herein include a computer program or computer program product comprising instructions, wherein execution of the program by a processing element is to cause the processing element to carry out one or more elements of the method 1000. The processor may be a processor of a base station (such as a processor(s) 1720 of a RAN device 1718 that is a base station, as described herein). These instructions may be, for example, located in the processor and/or on a memory of the base station (such as a memory 1722 of a RAN device 1718 that is a base station, as described herein).

### Ultra Compact DCI Designs for Downlink Data Transmission Scheduling

Embodiments for ultra compact DCI design in the case of the scheduling of a DL data transmission are now discussed.

Various formats for ultra compact DCI for DL data transmission are contemplated. In some embodiments, the ultra compact DCI may be of DCI format 1_2 as may be understood in definitions for some wireless communications systems. In some embodiments, an ultra compact DCI may be of DCI format that has a reduced payload size as compared to a payload size of a “compact DCI” as may be understood in definitions for some wireless communications systems. For example, in NR RAT, it may be that an ultra compact DCI may have a reduced payload size versus a “compact DCI” (e.g., that follows format 1_2), assuming equal situational circumstances.

An ultra compact DCI may include one or more fields related to the one or more scheduling PDSCHs that schedule a data PDSCH for a DL data transmission. These fields may indicate to the UE the manner of receiving and/or decoding the one or more scheduling PDSCHs at the UE. Then, based on the scheduling PDSCHs, the UE determines the scheduling of the data PDSCH and is thereby enabled to subsequently receive the data PDSCH.

The fields for the one or more scheduling PDSCHs in the ultra compact DCI may include a time domain resource allocation (TDRA) table index field for the one or more scheduling PDSCHs. This field may not be present in cases where time resources for the one or more scheduling PDSCHs are implicitly understood at the UE based on time and/or frequency resources on which the ultra compact DCI is received (e.g., by using a mapping scheme configured by an SIB).

The fields for the one or more scheduling PDSCHs in the ultra compact DCI may include a frequency domain resource allocation (FDRA) field for the one or more scheduling PDSCHs. This FDRA field may be configured to indicate a bitmap or a (starting resource block (RB), length of RB) pair in its field data. This field may not be present in cases where frequency resources for the one or more scheduling PDSCHs are implicitly understood at the UE based on time and/or frequency resources on which the ultra compact DCI is received (e.g., by using a mapping scheme configured by an SIB).

The fields for the one or more scheduling PDSCHs in the ultra compact DCI may include an MCS field for the one or more scheduling PDSCHs. This MCS field may indicate an absolute MCS for the one or more scheduling PDSCHs. Alternatively, this MCS filed may indicate a delta MCS relative to a reference MCS that has been configured to the UE by higher layers.

The fields for the one or more scheduling PDSCHs in the ultra compact DCI may include an RV field for the one or more scheduling PDSCHs.

The fields for the one or more scheduling PDSCHs in the ultra compact DCI may include a HARQ process number field for the one or more scheduling PDSCHs.

The fields for the one or more scheduling PDSCHs in the ultra compact DCI may include an NDI field for the one or more scheduling PDSCHs. It is contemplated that in some embodiments, no DCI-based retransmission of the one or more scheduling PDSCHs is allowed.

The fields for the one or more scheduling PDSCHs in the ultra compact DCI may include a downlink assignment indicator (DAI) field for the one or more scheduling PDSCHs. It is contemplated that in some embodiments, no aggregated HARQ-ACK feedback is allowed.

The fields for the one or more scheduling PDSCHs in the ultra compact DCI may include a number of PDSCH repetitions field for the one or more scheduling PDSCHs.

It is contemplated that in some embodiments, one of a number of PDSCH repetitions field and an MCS field is configured in an SIB, while the other is indicated in an ultra compact DCI. For example, if MCS information is configured in an SIB, it may be that the ultra compact DCI includes a number of PDSCH repetitions field for the one or more scheduling PDSCHs (and not an MCS field for the one or more PDSCH repetitions). As another example, if a number of PDSCH repetitions for the one or more scheduling PDSCHs is configured in an SIB, it may be that the ultra compact DCI includes an MCS field for the one or more scheduling PDSCHs (and not a number of PDSCH repetitions field for the one or more scheduling PDSCHs).

In some embodiments, one or more of a TDRA table index field, an FDRA field, an MCS field, an RV field, a HARQ process number field, an NDI field, a DAI field, and/or a number of PDSCH repetitions field found in the ultra compact DCI may use fixed data. In other words, one or more of these fields may use pre-determined data. This may be useful in the case where a UE does not use/need data from these fields (e.g., because the UE is configured to operate without this data, or is made aware of this data in another way), but where the inclusion of the fields (with the fixed data) makes the ultra compact DCI easier to decode. This may occur, for example, in the case that the fixed data is known to (and therefore expected at) the UE. In such cases, the inclusion of the fields having the fixed data as expected by the UE promotes the ability of the UE to perform polar or linear decoding on the ultra compact DCI as a whole.

An ultra compact DCI may include one or more fields related to HARQ-ACK signaling for the one or more scheduling PDSCHs. As described herein, in some embodiments, a PUCCH comprising HARQ-ACK signaling for the one or more scheduling PDSCHs is sent by the UE in response to its receipt of the one or more scheduling PDSCHs. Accordingly, the data in these fields may relate to the manner of encoding and/or transmitting the PUCCH having this HARQ-ACK signaling.

The fields for the HARQ-ACK signaling for the one or more scheduling PDSCHs may include a PUCCH resource indicator field for the HARQ-ACK signaling.

The fields for the HARQ-ACK signaling for the one or more scheduling PDSCHs may include a transmit power control (TPC) command field for the HARQ-ACK signaling.

The fields for the HARQ-ACK signaling for the one or more scheduling PDSCHs may include a PDSCH-to-HARQ_feedback timing indicator field for the HARQ-ACK signaling.

In other embodiments, one or more of these fields related to HARQ-ACK signaling for the one or more scheduling PDSCHs may not be present in the ultra compact DCI (or alternatively may contain fixed values that are not actively used by the UE, in order to promote decoding of the ultra compact DCI). This situation may correspond to cases, as discussed herein, where HARQ-ACK signaling for the one or more scheduling PDSCHs is not used, or where one or more data items corresponding to these fields is provided to the UE in the one or more PDSCHs (e.g., in MAC CE of these one or more PDSCHs) that are scheduled by the ultra compact DCI rather than in the ultra compact DCI itself.

The omission of/fixing of these fields may also correspond to a case where a base station is configured to infer whether the UE successfully received/decoded the one or more scheduling PDSCHs from HARQ-ACK signaling for the data PDSCH. In such cases, the failure to receive expected HARQ-ACK signaling for the data PDSCH may imply that the one or more scheduling PDSCHs were not received and/or were not successfully decoded at the UE.

The ultra compact DCI may omit/fix these fields in cases where a HARQ process number used by the one or more scheduling PDSCHs is configured with HARQ feedback disabled. In such cases, no HARQ-ACK signaling for the one or more scheduling PDSCHs would be expected by the network.

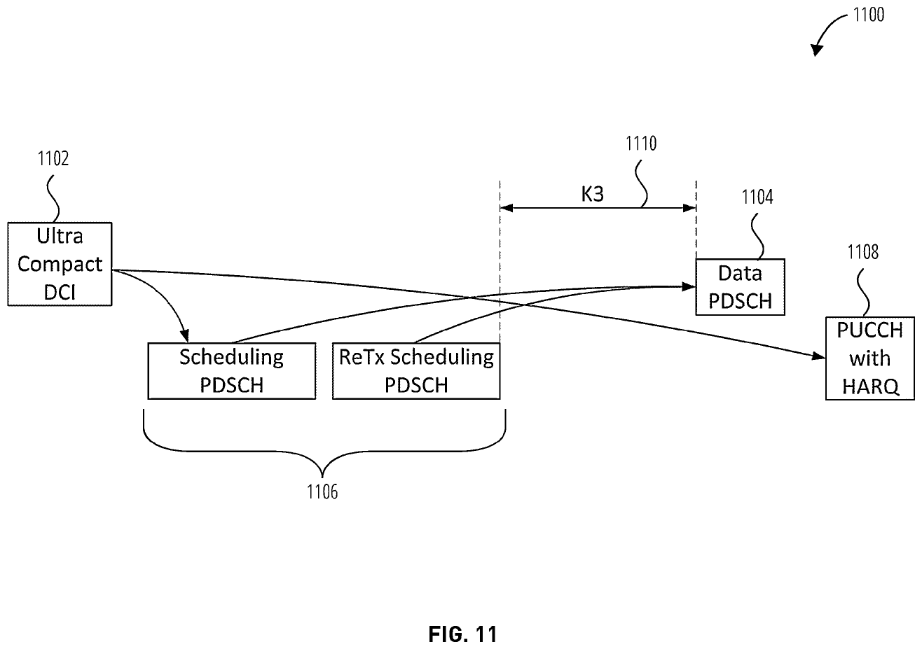

In some embodiments where one or more of these fields are included (and are not fixed) in the ultra compact DCI, it may be that the UE uses the PUCCH for both HARQ-ACK signaling for the one or more scheduling PDSCHs and the data PDSCH. FIG. 11 illustrates a diagram 1100 for a dynamic resource grant procedure for DL data transmission, according to an embodiment. More specifically, the diagram 1100 illustrates the use of an ultra compact DCI 1102 to schedule one or more scheduling PDSCHs 1106 that then schedule a data PDSCH 1108 for the DL data transmission. The diagram 1100 of FIG. 11 additionally illustrates the scheduling and use of the PUCCH 1104 having HARQ-ACK signaling for the one or more scheduling PDSCHs 1106. In the embodiment of FIG. 11, note that the PUCCH 1104 occurs after the data PDSCH 1108.

The ultra compact DCI 1102 may include one or more of a PUCCH resource indicator field for HARQ-ACK signaling for the one or more scheduling PDSCHs 1106, a TPC command field for the HARQ-ACK signaling for the one or more scheduling PDSCHs 1106, and/or a PDSCH-to-HARQ_feedback timing indicator field for the HARQ-ACK signaling for the one or more scheduling PDSCHs 1106. As illustrated in FIG. 11, data from one or more of these field(s) may be used to schedule the PUCCH 1104 and/or to determine the manner of transmitting the PUCCH 1104.

Further, the UE may be configured to use the PUCCH 1104 for HARQ-ACK signaling for the data PDSCH 1108 (in addition to using it for the HARQ-ACK signaling for the one or more scheduling PDSCHs 1106). In such cases, the total HARQ-ACK signaling may include two bits (one for each type of HARQ-ACK signaling). In such cases, a first of the two bits may provide HARQ-ACK signaling for the one or more scheduling PDSCHs 1106, while a second of the two bits may provide HARQ-ACK signaling for the data PDSCH 1108. For example, the inclusion of the two bits “10” in the PUCCH 1104 may mean that the one or more scheduling PDSCHs 1106 were received (corresponding to the “1” in the first bit) and that the data PDSCH 1108 was not received (corresponding to the “0” in the second bit).

In embodiments according to FIG. 11, it may be that the MAC CE of the one or more scheduling PDSCHs 1106 does not schedule a PUCCH for HARQ-ACK signaling for the data PDSCH 1108 (as this HARQ-ACK signaling is instead sent in the PUCCH 1104 as scheduled by the ultra compact DCI 1102 for both the HARQ-ACK signaling for the one or more scheduling PDSCHs 1106 and the HARQ-ACK signaling for the data PDSCH 1108). Further, it may be that an offset K3 1110 in such cases may not need to be larger than a UE-base station RTT (because there is no need to account for UL signaling of a PUCCH between the one or more scheduling PDSCHs 1106 and the data PDSCH 1108 in such circumstances).

### Ultra Compact DCI Designs for Uplink Data Transmission Scheduling

Embodiments for ultra compact DCI design in the case of the scheduling of an UL data transmission are now discussed.

Various formats for ultra compact DCI for scheduling of an UL data transmission are contemplated. In some embodiments, the ultra compact DCI may be of DCI format 1_2 as may be understood in definitions for some wireless communications systems. In some embodiments, an ultra compact DCI may be of a DCI format that has a reduced payload size as compared to a payload size of a “compact DCI” as may be understood in definitions for some wireless communications systems. For example, in NR RAT, it may be that an ultra compact DCI may have a reduced payload size versus a “compact DCI” (e.g., that follows format 1_2), assuming equal situational circumstances.

An ultra compact DCI may include one or more fields related to the one or more scheduling PDSCHs that schedule a PUSCH for an UL data transmission. These fields may indicate to the UE the manner of receiving and/or decoding the one or more scheduling PDSCHs at the UE. Then, based on the scheduling PDSCHs, the UE determines the scheduling of the PUSCH and is thereby enabled to subsequently transmit the PUSCH in such a way that it may be received by the base station.

The fields for the one or more scheduling PDSCHs in the ultra compact DCI may include a TDRA table index field for the one or more scheduling PDSCHs. This field may not be present in cases where time resources for the one or more scheduling PDSCHs are implicitly understood at the UE based on time and/or frequency resources on which the ultra compact DCI is received (e.g., by using a mapping scheme configured by an SIB).

The fields for the one or more scheduling PDSCHs in the ultra compact DCI may include a FDRA field for the one or more scheduling PDSCHs. This field may not be present in cases where frequency resources for the one or more scheduling PDSCHs are implicitly understood at the UE based on time and/or frequency resources on which the ultra compact DCI is received (e.g., by using a mapping scheme configured by an SIB).

The fields for the one or more scheduling PDSCHs in the ultra compact DCI may include an MCS field for the one or more scheduling PDSCHs. This MCS field may indicate an absolute MCS for the one or more scheduling PDSCHs. Alternatively, this MCS field may indicate a delta MCS relative to a reference MCS that has been configured to the UE by higher layers.

The fields for the one or more scheduling PDSCHs in the ultra compact DCI may include an RV field for the one or more scheduling PDSCHs.

The fields for the one or more scheduling PDSCHs in the ultra compact DCI may include a HARQ process number field for the one or more scheduling PDSCHs.

The fields for the one or more scheduling PDSCHs in the ultra compact DCI may include an NDI field for the one or more scheduling PDSCHs. It is contemplated that in some embodiments, no DCI-based retransmission of the one or more scheduling PDSCHs is allowed.

The fields for the one or more scheduling PDSCHs in the ultra compact DCI may include a DAI field for the one or more scheduling PDSCHs. It is contemplated that in some embodiments, no aggregated HARQ-ACK feedback is allowed.

The fields for the one or more scheduling PDSCHs in the ultra compact DCI may include a number of PDSCH repetitions field for the one or more scheduling PDSCHs.

It is contemplated that in some embodiments, one of a number of PDSCH repetitions field and an MCS field is configured in an SIB, while the other is indicated in the ultra compact DCI. For example, if MCS information is configured in an SIB, it may be that the ultra compact DCI includes a number of PDSCH repetitions field for the one or more scheduling PDSCHs (and not an MCS field for the one or more PDSCH repetitions). As another example, if a number of PDSCH repetitions for the one or more scheduling PDSCHs is configured in an SIB, it may be that the ultra compact DCI includes an MCS field for the one or more scheduling PDSCHs (and not a number of PDSCH repetitions field for the one or more scheduling PDSCHs).

In some embodiments, one or more of an MCS field, an RV field, a HARQ process number field, an NDI field, a DAI field, and/or a number of PDSCH repetitions field found in the ultra compact DCI may use fixed data. In other words, one or more of these fields may use pre-determined data. This may be useful in the case where a UE does not use/need data from these fields (e.g., because the UE is configured to operate without this data, or is made aware of this data in another way), but where the inclusion of the fields (with the fixed data) makes the ultra compact DCI easier to decode. This may occur, for example, in the case that the fixed data is known to (and therefore expected at) the UE. In such cases, the inclusion of the fields having the fixed data as expected by the UE promotes the ability of the UE to perform polar or linear decoding on the ultra compact DCI as a whole.

An ultra compact DCI may include one or more fields related to the PUSCH. For example, the ultra compact DCI may include a TPC command for the PUSCH that controls the power at which the UE transmits the PUSCH.

An ultra compact DCI may include one or more fields related to HARQ-ACK signaling for the one or more scheduling PDSCHs. As described herein, in some embodiments, a PUCCH comprising HARQ-ACK signaling for the one or more scheduling PDSCHs is sent by the UE in response to its receipt of the one or more scheduling PDSCHs. Accordingly, the data in these fields may relate to the manner of encoding and/or transmitting the PUCCH having this HARQ-ACK signaling.

The fields for the HARQ-ACK signaling for the one or more scheduling PDSCHs may include a PUCCH resource indicator field for the HARQ-ACK signaling.

The fields for the HARQ-ACK signaling for the one or more scheduling PDSCHs may include a TPC command field for the HARQ-ACK signaling.

The fields for the HARQ-ACK signaling for the one or more scheduling PDSCHs may include a PDSCH-to-HARQ_feedback timing indicator field for the HARQ-ACK signaling.

In other embodiments, one or more of these fields related to HARQ-ACK signaling for the one or more scheduling PDSCHs may not be present in the ultra compact DCI (or alternatively may contain fixed values that are not actively used by the UE, in order to promote decoding of the ultra compact DCI). This situation may correspond to cases, as discussed herein, where HARQ-ACK signaling for the one or more scheduling PDSCHs is not used, or where one or more data items corresponding to these fields is provided to the UE in the one or more PDSCHs (e.g., in MAC CE of these one or more PDSCHs) that are scheduled by the ultra compact DCI rather than in the ultra compact DCI itself.

The ultra compact DCI may omit/fix these fields in cases where a HARQ process number used by the one or more scheduling PDSCHs is configured with HARQ feedback disabled. In such cases, no HARQ-ACK signaling for the one or more scheduling PDSCHs would be expected by the network.

Note that one of ordinary skill with possession of this disclosure may understand that one or more features discussed in the section “Ultra Compact DCI Designs for Downlink Data Transmission Scheduling” might be useable as well in an UL data transmission scheduling case, and/or that various features discussed in the section “Ultra Compact DCI Designs for Uplink Data Transmission Scheduling” might be useable as well in a DL data transmission scheduling case. Accordingly, the use of these section headings herein is provided for organizational purposes only, and should not be construed as a hard limit to any crossover of features between the cases as may be appropriate.

### Additional Ultra Compact DCI Design Considerations

An ultra compact DCI may be received in a PDCCH that has cyclic redundancy check (CRC) bits that are scrambled by one of a cell radio network temporary identifier (RNTI) (C-RNTI), a configured scheduling RNTI (CS-RNTI), a modulation and coding scheme cell RNTI (MCS-C-RNTI), a random access RNTI (RA-RNTI), a temporary cell RNTI (TC-RNTI) (with DCI format 1_0), a paging RNTI (P-RNTI), and a system information RNTI (SI-RNTI).

To support such scrambling using RA-RNTI, a PDSCH repetition number for the one or more scheduling PDSCHs may be indicated to the UE. In one embodiment, a PDSCH repetition number for the one or more scheduling PDSCHs may be indicated in an SIB that is sent to the UE. In another embodiment, a PDSCH repetition number for the one or more scheduling PDSCHs may be indicated in a random access response (RAR) that is sent by the base station to the UE. In this case, the RAR may use an MCS field, and a subset of the MCS field may be used to indicate the PDSCH repetition number. For example, it may be that the MCS field has four bits, and two of the four bits are used to indicate the PDSCH repetition number.

It may be that cases where the P-RNTI or the SI-RNTI are used, the associated ultra compact DCI has been broadcast (e.g., is configured for use by more than one UE). Accordingly, it may be that the use of P-RNTI or SI-RNTI in this manner corresponds to cases where a PUCCH having HARQ-ACK signaling for the one or more scheduling PDSCHs is not used.

In some embodiments, the ultra compact DCI may be received in one or more PDCCH repetitions. These repetitions may be intra-slot repetitions for inter-slot repetitions. When using PDCCH repetitions, it may be the case that some or all of the PDCCH repetitions overlap with slots occupied by synchronization signaling blocks (SSBs) to be transmitted by the base station. In some such cases, the PDCCH repetition(s) of the overlap are skipped. In some such cases, the PDCCH repetition(s) of the overlap are deferred.

In some embodiments, an ultra compact DCI is received in one or more of a plurality of PDCCHs, where each of the plurality of PDCCHs is transmitted by a different transmission reception point (TRP). In such cases, it may be that each of the plurality of PDCCHs is associated with a different search space set (e.g., that corresponds to the TRP of the PDCCH).

In such circumstances, it may be that the plurality of PDCCHs are time division multiplexed (TDMed) with each other. In some such embodiments, the PDCCHs from the multiple TRPs may be TDMed in a single slot. In other such embodiments, the PDCCHs from the multiple TRPs may be TDMed in across different/multiple slots.

It may (additionally or alternatively) be that the plurality of PDCCHs are frequency division multiplexed (FDMed) with each other. In such embodiments, it may be that the different frequency locations of the search space sets for the PDCCHs are used for this frequency division multiplexing.

It may (additionally or alternatively) be that the plurality of PDCCHs are spatial division multiplexed (SDMed) (e.g., may each be sent using a different/particular beam direction that is determined according to the TRP for the particular PDCCH).

When using a plurality of PDCCHs, it may be that the plurality of PDCCHs uses PDCCH repetitions. In other words, it may be that some or all of the plurality of PDCCHs is identical (e.g., has the same contents). In this case, the receipt of two or more of the PDCCHs at the UE allows the UE to leverage the experienced gain of those repetitions to help in decoding an ultra compact DCI from the PDCCHs.

In other cases, it may be that the plurality of PDCCHs each transmit different contents corresponding to the ultra compact DCI (e.g., may each use DCI including having some portion of the contents of a single (logical) ultra compact DCI as has been described herein). Accordingly, first field(s) for an ultra compact DCI may be included in a first of the plurality of PDCCHs, while second field(s) for the same ultra compact DCI may be included in a second of the plurality of PDCCHs, etc. Upon receiving a set of such PDCCHs having the representative portions of the ultra compact DCI, the UE is able to determine the ultra compact DCI.

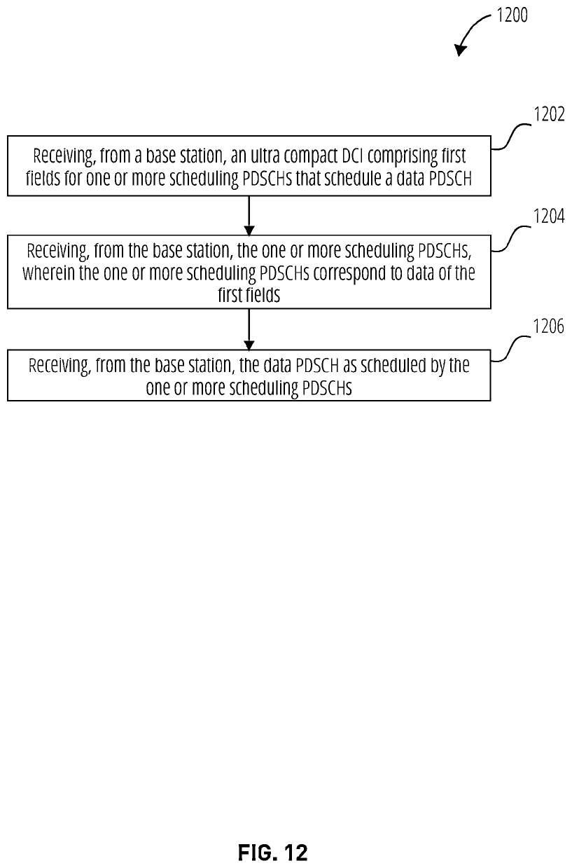

FIG. 12 illustrates a method 1200 of a UE, according to an embodiment. The method 1200 includes receiving 1202, from a base station, an ultra compact DCI comprising first fields for one or more scheduling PDSCHs that schedule a data PDSCH.

The method 1200 further includes receiving 1204, from the base station, the one or more scheduling PDSCHs, wherein the one or more scheduling PDSCHs correspond to data of the first fields.

The method 1200 further includes receiving 1206, from the base station, the data PDSCH as scheduled by the one or more scheduling PDSCHs.

In some embodiments of the method 1200, the first fields for the one or more scheduling PDSCHs comprise one or more of a TDRA table index field for the one or more scheduling PDSCHs, a FDRA field for the one or more scheduling PDSCHs, an MCS field for the one or more scheduling PDSCHs, an RV field for the one or more scheduling PDSCHs, a HARQ process number field for the one or more scheduling PDSCHs, an NDI field for the one or more scheduling PDSCHs, a DAI field for the one or more scheduling PDSCHs, and a number of PDSCH repetitions field for the one or more scheduling PDSCHs. In some of these embodiments, one or more of the MCS field, the RV field, the HARQ process number field, the NDI field, the DAI field, and the number of PDSCH repetitions field comprises fixed data.

In some embodiments, the method 1200 further includes transmitting, to the base station, a PUCCH comprising first HARQ-ACK signaling for the one or more scheduling PDSCHs, wherein the ultra compact DCI further comprises second fields for the first HARQ-ACK signaling for the one or more scheduling PDSCHs.

In some of these embodiments, the second fields for the first HARQ-ACK signaling comprise one or more of a PUCCH resource indicator field for the first HARQ-ACK signaling, a TPC command field for the first HARQ-ACK signaling, and a PDSCH-to-HARQ_feedback timing indicator field for the first HARQ-ACK signaling. In some of these cases, one or more of the PUCCH resource indicator field, the TPC command field, and the PDSCH-to-HARQ_feedback timing indicator field that is present in the ultra compact DCI comprises fixed data.

In some of these embodiments, the PUCCH further comprises second HARQ-ACK signaling for the data PDSCH.

In some embodiments of the method 1200, the ultra compact DCI is received in a PDCCH having CRC bits that are scrambled by one of a C-RNTI, a CS-RNTI, an MCS-C-RNTI, an RA-RNTI, a TC-RNTI, a P-RNTI, and an SI-RNTI.

In some embodiments of the method 1200, the ultra compact DCI is received in one or more PDCCH repetitions.

In some embodiments of the method 1200, the ultra compact DCI is received in one or more of a plurality of PDCCHs, wherein each of the plurality of PDCCHs is transmitted by a different TRP. In some of these embodiments, each of the plurality of PDCCHs is associated with a different search space set. In some of these embodiments, the plurality of PDCCHs is one or more of TDMed, FDMed, and SDMed. In some of these embodiments, each of the plurality of PDCCHs is identical.

In some embodiments of the method 1200, the ultra compact DCI has a first payload size that is smaller than a second payload size of a compact DCI.

In some embodiments of the method 1200, the ultra compact DCI is of DCI format 1_2.

Embodiments contemplated herein include an apparatus comprising means to perform one or more elements of the method 1200. This apparatus may be, for example, an apparatus of a UE (such as a wireless device 1702 that is a UE, as described herein).

Embodiments contemplated herein include one or more non-transitory computer-readable media comprising instructions to cause an electronic device, upon execution of the instructions by one or more processors of the electronic device, to perform one or more elements of the method 1200. This non-transitory computer-readable media may be, for example, a memory of a UE (such as a memory 1706 of a wireless device 1702 that is a UE, as described herein).

Embodiments contemplated herein include an apparatus comprising logic, modules, or circuitry to perform one or more elements of the method 1200. This apparatus may be, for example, an apparatus of a UE (such as a wireless device 1702 that is a UE, as described herein).

Embodiments contemplated herein include an apparatus comprising: one or more processors and one or more computer-readable media comprising instructions that, when executed by the one or more processors, cause the one or more processors to perform one or more elements of the method 1200. This apparatus may be, for example, an apparatus of a UE (such as a wireless device 1702 that is a UE, as described herein).

Embodiments contemplated herein include a signal as described in or related to one or more elements of the method 1200.

Embodiments contemplated herein include a computer program or computer program product comprising instructions, wherein execution of the program by a processor is to cause the processor to carry out one or more elements of the method 1200. The processor may be a processor of a UE (such as a processor(s) 1704 of a wireless device 1702 that is a UE, as described herein). These instructions may be, for example, located in the processor and/or on a memory of the UE (such as a memory 1706 of a wireless device 1702 that is a UE, as described herein).

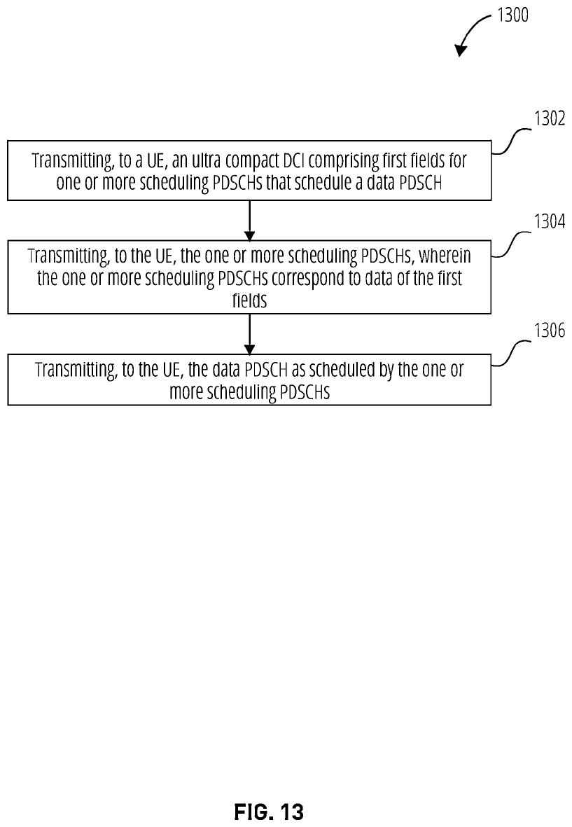

FIG. 13 illustrates a method 1300 of a base station, according to an embodiment. The method 1300 includes transmitting 1302, to a UE, an ultra compact DCI comprising first fields for one or more scheduling PDSCHs that schedule a data PDSCH.

The method 1300 further includes transmitting 1304, to the UE, the one or more scheduling PDSCHs, wherein the one or more scheduling PDSCHs correspond to data of the first fields.

The method 1300 further includes transmitting 1306, to the UE, the data PDSCH as scheduled by the one or more scheduling PDSCHs.

In some embodiments of the method 1300, the first fields for the one or more scheduling PDSCHs comprise one or more of a TDRA table index field for the one or more scheduling PDSCHs, a FDRA field for the one or more scheduling PDSCHs, an MCS field for the one or more scheduling PDSCHs, an RV field for the one or more scheduling PDSCHs, a HARQ process number field for the one or more scheduling PDSCHs, an NDI field for the one or more scheduling PDSCHs, a DAI field for the one or more scheduling PDSCHs, and a number of PDSCH repetitions field for the one or more scheduling PDSCHs. In some of these embodiments, one or more of the MCS field, the RV field, the HARQ process number field, the NDI field, the DAI field, and the number of PDSCH repetitions field comprises fixed data.

In some embodiments, the method 1300 further includes receiving, from the UE, a PUCCH comprising first HARQ-ACK signaling for the one or more scheduling PDSCHs, wherein the ultra compact DCI further comprises second fields for the first HARQ-ACK signaling for the one or more scheduling PDSCHs.

In some of these embodiments, the second fields for the first HARQ-ACK signaling comprise one or more of a PUCCH resource indicator field for the first HARQ-ACK signaling, a TPC command field for the first HARQ-ACK signaling, and a PDSCH-to-HARQ_feedback timing indicator field for the first HARQ-ACK signaling. In some of these cases, one or more of the PUCCH resource indicator field, the TPC command field, and the PDSCH-to-HARQ_feedback timing indicator field that is present in the ultra compact DCI comprises fixed data.

In some of these embodiments, the PUCCH further comprises second HARQ-ACK signaling for the data PDSCH.

In some embodiments of the method 1300, the ultra compact DCI is transmitted in a PDCCH having CRC bits that are scrambled by one of a C-RNTI, a CS-RNTI, an MCS-C-RNTI, an RA-RNTI, a TC-RNTI, a P-RNTI, and an SI-RNTI.

In some embodiments of the method 1300, the ultra compact DCI is transmitted in one or more PDCCH repetitions.

In some embodiments of the method 1300, the ultra compact DCI has a first payload size that is smaller than a second payload size of a compact DCI.

In some embodiments of the method 1300, the ultra compact DCI is of DCI format 1_2.

Embodiments contemplated herein include an apparatus comprising means to perform one or more elements of the method 1300. This apparatus may be, for example, an apparatus of a base station (such as a RAN device 1718 that is a base station, as described herein).

Embodiments contemplated herein include one or more non-transitory computer-readable media comprising instructions to cause an electronic device, upon execution of the instructions by one or more processors of the electronic device, to perform one or more elements of the method 1300. This non-transitory computer-readable media may be, for example, a memory of a base station (such as a memory 1722 of a RAN device 1718 that is a base station, as described herein).

Embodiments contemplated herein include an apparatus comprising logic, modules, or circuitry to perform one or more elements of the method 1300. This apparatus may be, for example, an apparatus of a base station (such as a RAN device 1718 that is a base station, as described herein).

Embodiments contemplated herein include an apparatus comprising: one or more processors and one or more computer-readable media comprising instructions that, when executed by the one or more processors, cause the one or more processors to perform one or more elements of the method 1300. This apparatus may be, for example, an apparatus of a base station (such as a RAN device 1718 that is a base station, as described herein).

Embodiments contemplated herein include a signal as described in or related to one or more elements of the method 1300.

Embodiments contemplated herein include a computer program or computer program product comprising instructions, wherein execution of the program by a processing element is to cause the processing element to carry out one or more elements of the method 1300. The processor may be a processor of a base station (such as a processor(s) 1720 of a RAN device 1718 that is a base station, as described herein). These instructions may be, for example, located in the processor and/or on a memory of the base station (such as a memory 1722 of a RAN device 1718 that is a base station, as described herein).

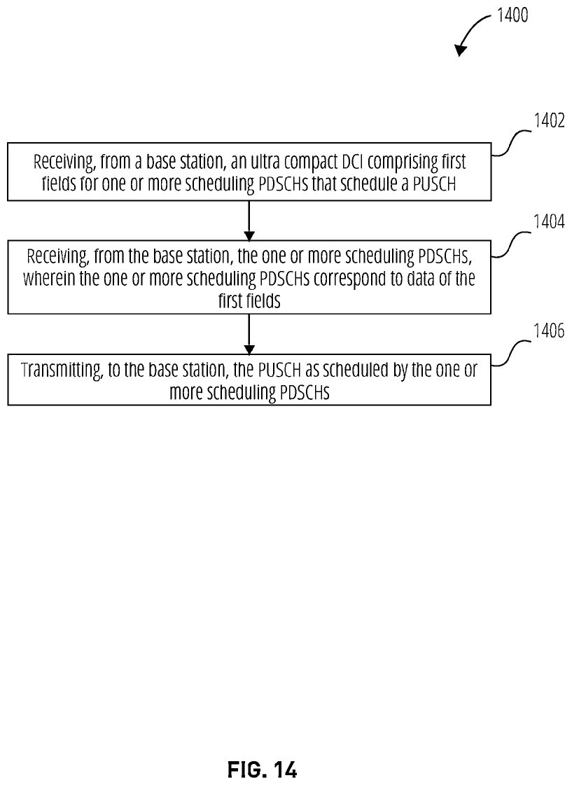

FIG. 14 illustrates method 1400 of a UE, according to an embodiment. The method 1400 includes receiving 1402, from a base station, an ultra compact DCI comprising first fields for one or more scheduling PDSCHs that schedule a PUSCH.

The method 1400 further includes receiving 1404, from the base station, the one or more scheduling PDSCHs, wherein the one or more scheduling PDSCHs correspond to data of the first fields.

The method 1400 further includes transmitting 1406, to the base station, the PUSCH as scheduled by the one or more scheduling PDSCHs.

In some embodiments of the method 1400, the first fields for the one or more scheduling PDSCHs comprise one or more of a TDRA table index field for the one or more scheduling PDSCHs, an FDRA field for the one or more scheduling PDSCHs, an MCS field for the one or more scheduling PDSCHs, an RV field for the one or more scheduling PDSCHs, a HARQ process number field for one or more scheduling PDSCHs, an NDI field for the one or more scheduling PDSCHs, a DAI field for the one or more scheduling PDSCHs, and a number of PDSCH repetitions field within the one or more scheduling PDSCHs. In some of these embodiments, one or more of the MCS field, the RV field, the HARQ process number field, the NDI field, the DAI field, and the number of PDSCH repetitions field that is present in the ultra compact DCI comprises fixed data.

In some embodiments of the method 1400, the ultra compact DCI further comprises a TPC command for the PUSCH.

In some embodiments, the method 1400 further includes transmitting, to the base station, a PUCCH comprising HARQ-ACK signaling for the one or more scheduling PDSCHs, wherein the ultra compact DCI further comprises second fields for the HARQ-ACK signaling. In some of these embodiments, the second fields for the HARQ-ACK signaling comprise one or more of a PUCCH resource indicator field for the HARQ-ACK signaling, a TPC command field for the HARQ-ACK signaling, and a PDSCH-to-HARQ_feedback timing indicator field for the HARQ-ACK signaling. In some of these cases, one or more of the PUCCH resource indicator field, the TPC command field, and the PDSCH-to-HARQ_feedback timing indicator field that is present in the ultra compact DCI comprises fixed data.

In some embodiments of the method 1400, the ultra compact DCI is received in a PDCCH having CRC bits that are scrambled by one of a C-RNTI, a CS-RNTI, an MCS-C-RNTI, an RA-RNTI, a TC-RNTI, a P-RNTI, and an SI-RNTI.

In some embodiments of the method 1400, the ultra compact DCI is received in one or more PDCCH repetitions.

In some embodiments of the method 1400, the ultra compact DCI is received in one or more of a plurality of PDCCHs, wherein each of the plurality of PDCCHs is transmitted by a different TRP. In some of these embodiments, each of the plurality of PDCCHs is associated with a different search space set. In some of these embodiments, the plurality of PDCCHs is one or more of TDMed, FDMed, and SDMed. In some of these embodiments, each of the plurality of PDCCHs is identical.

In some embodiments of the method 1400, the ultra compact DCI has a first payload size that is smaller than a second payload size of a compact DCI.

In some embodiments of the method 1400, the ultra compact DCI is of DCI format 1_2.

Embodiments contemplated herein include an apparatus comprising means to perform one or more elements of the method 1400. This apparatus may be, for example, an apparatus of a UE (such as a wireless device 1702 that is a UE, as described herein).

Embodiments contemplated herein include one or more non-transitory computer-readable media comprising instructions to cause an electronic device, upon execution of the instructions by one or more processors of the electronic device, to perform one or more elements of the method 1400. This non-transitory computer-readable media may be, for example, a memory of a UE (such as a memory 1706 of a wireless device 1702 that is a UE, as described herein).

Embodiments contemplated herein include an apparatus comprising logic, modules, or circuitry to perform one or more elements of the method 1400. This apparatus may be, for example, an apparatus of a UE (such as a wireless device 1702 that is a UE, as described herein).

Embodiments contemplated herein include an apparatus comprising: one or more processors and one or more computer-readable media comprising instructions that, when executed by the one or more processors, cause the one or more processors to perform one or more elements of the method 1400. This apparatus may be, for example, an apparatus of a UE (such as a wireless device 1702 that is a UE, as described herein).

Embodiments contemplated herein include a signal as described in or related to one or more elements of the method 1400.

Embodiments contemplated herein include a computer program or computer program product comprising instructions, wherein execution of the program by a processor is to cause the processor to carry out one or more elements of the method 1400. The processor may be a processor of a UE (such as a processor(s) 1704 of a wireless device 1702 that is a UE, as described herein). These instructions may be, for example, located in the processor and/or on a memory of the UE (such as a memory 1706 of a wireless device 1702 that is a UE, as described herein).

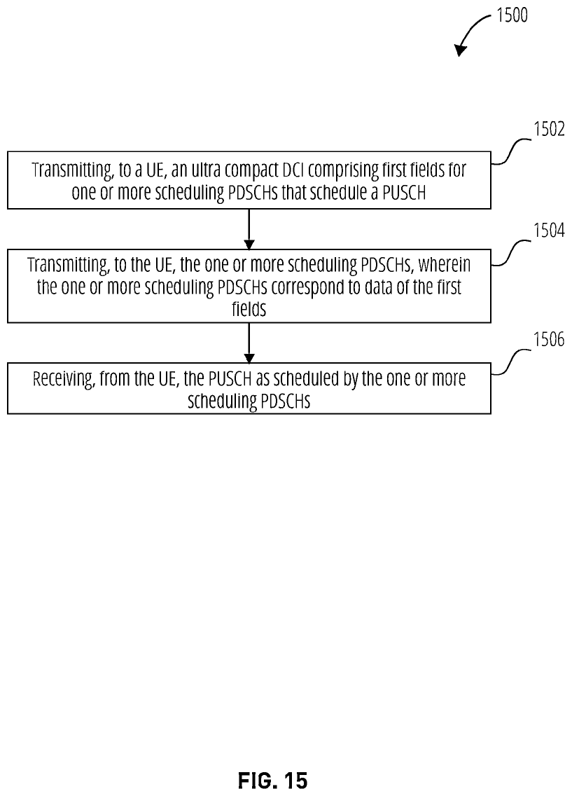

FIG. 15 illustrates a method 1500 of a base station, according to an embodiment. The method 1500 includes transmitting 1502, to a UE, an ultra compact DCI comprising first fields for one or more scheduling PDSCHs that schedule a PUSCH.

The method 1500 further includes transmitting 1504, to the UE, the one or more scheduling PDSCHs, wherein the one or more scheduling PDSCHs correspond to data of the first fields.

The method 1500 further includes receiving 1506, from the UE, the PUSCH as scheduled by the one or more scheduling PDSCHs.

In some embodiments of the method 1500, the first fields for the one or more scheduling PDSCHs comprise one or more of a TDRA table index field for the one or more scheduling PDSCHs, an FDRA field for the one or more scheduling PDSCHs, an MCS field for the one or more scheduling PDSCHs, an RV field for the one or more scheduling PDSCHs, a HARQ process number field for one or more scheduling PDSCHs, an NDI field for the one or more scheduling PDSCHs, a DAI field for the one or more scheduling PDSCHs, and a number of PDSCH repetitions field within the one or more scheduling PDSCHs. In some of these embodiments, one or more of the MCS field, the RV field, the HARQ process number field, the NDI field, the DAI field, and the number of PDSCH repetitions field that is present in the ultra compact DCI comprises fixed data.

In some embodiments of the method 1500, the ultra compact DCI further comprises a TPC command for the PUSCH.

In some embodiments, the method 1500 further includes receiving, from the UE, a PUCCH comprising HARQ-ACK signaling for the one or more scheduling PDSCHs, wherein the ultra compact DCI further comprises second fields for the HARQ-ACK signaling. In some of these embodiments, the second fields for the HARQ-ACK signaling comprise one or more of a PUCCH resource indicator field for the HARQ-ACK signaling, a TPC command field for the HARQ-ACK signaling, and a PDSCH-to-HARQ_feedback timing indicator field for the HARQ-ACK signaling. In some of these cases, one or more of the PUCCH resource indicator field, the TPC command field, and the PDSCH-to-HARQ_feedback timing indicator field that is present in the ultra compact DCI comprises fixed data.

In some embodiments of the method 1500, the ultra compact DCI is received in a PDCCH having CRC bits that are scrambled by one of a C-RNTI, a CS-RNTI, an MCS-C-RNTI, an RA-RNTI, a TC-RNTI, a P-RNTI, and an SI-RNTI.

In some embodiments of the method 1500, the ultra compact DCI is transmitted in one or more PDCCH repetitions.

In some embodiments of the method 1500, the ultra compact DCI has a first payload size that is smaller than a second payload size of a compact DCI.

In some embodiments of the method 1500, the ultra compact DCI is of DCI format 1_2.

Embodiments contemplated herein include an apparatus comprising means to perform one or more elements of the method 1500. This apparatus may be, for example, an apparatus of a base station (such as a RAN device 1718 that is a base station, as described herein).

Embodiments contemplated herein include one or more non-transitory computer-readable media comprising instructions to cause an electronic device, upon execution of the instructions by one or more processors of the electronic device, to perform one or more elements of the method 1500. This non-transitory computer-readable media may be, for example, a memory of a base station (such as a memory 1722 of a RAN device 1718 that is a base station, as described herein).

Embodiments contemplated herein include an apparatus comprising logic, modules, or circuitry to perform one or more elements of the method 1500. This apparatus may be, for example, an apparatus of a base station (such as a RAN device 1718 that is a base station, as described herein).

Embodiments contemplated herein include an apparatus comprising: one or more processors and one or more computer-readable media comprising instructions that, when executed by the one or more processors, cause the one or more processors to perform one or more elements of the method 1500. This apparatus may be, for example, an apparatus of a base station (such as a RAN device 1718 that is a base station, as described herein).

Embodiments contemplated herein include a signal as described in or related to one or more elements of the method 1500.

Embodiments contemplated herein include a computer program or computer program product comprising instructions, wherein execution of the program by a processing element is to cause the processing element to carry out one or more elements of the method 1500. The processor may be a processor of a base station (such as a processor(s) 1720 of a RAN device 1718 that is a base station, as described herein). These instructions may be, for example, located in the processor and/or on a memory of the base station (such as a memory 1722 of a RAN device 1718 that is a base station, as described herein).

FIG. 16 illustrates an example architecture of a wireless communication system 1600, according to embodiments disclosed herein. The following description is provided for an example wireless communication system 1600 that operates in conjunction with the LTE system standards and/or 5G or NR system standards as provided by 3GPP technical specifications and other 3GPP documents.

As shown by FIG. 16, the wireless communication system 1600 includes UE 1602 and UE 1604 (although any number of UEs may be used). In this example, the UE 1602 and the UE 1604 are illustrated as smartphones (e.g., handheld touchscreen mobile computing devices connectable to one or more cellular networks), but may also comprise any mobile or non-mobile computing device configured for wireless communication.

The UE 1602 and UE 1604 may be configured to communicatively couple with a RAN 1606. In embodiments, the RAN 1606 may be NG-RAN, E-UTRAN, etc. The UE 1602 and UE 1604 utilize connections (or channels) (shown as connection 1608 and connection 1610, respectively) with the RAN 1606, each of which comprises a physical communications interface. The RAN 1606 can include one or more base stations (such as terrestrial base station 1612, the terrestrial base station 1614 the satellite base station 1636 and the satellite base station 1638) and/or other entities (e.g., the satellite 1642, which may not have base station functionality) that enable the connection 1608 and connection 1610. One or more satellite gateways 1634 may integrate the satellite base station 1636, satellite base station 1638, and/or the satellite 1642 into the RAN 1606, in the manners (and with the appropriate elements) described in relation to the NTN architecture 100 of FIG. 1 and the NTN architecture 200 of FIG. 2.

In this example, the connection 1608 and connection 1610 are air interfaces to enable such communicative coupling, and may be consistent with RAT(s) used by the RAN 1606, such as, for example, an LTE and/or NR. It is contemplated that the connection 1608 and connection 1610 may include, in some embodiments, service links between their respective UE 1602, UE 1604 and one or more of the satellite base station 1636, the satellite base station 1638, and the satellite 1642.

In some embodiments, the UE 1602 and UE 1604 may also directly exchange communication data via a sidelink interface 1616.

The UE 1604 is shown to be configured to access an access point (shown as AP 1618) via connection 1620. By way of example, the connection 1620 can comprise a local wireless connection, such as a connection consistent with any IEEE 802.11 protocol, wherein the AP 1618 may comprise a Wi-Fi® router. In this example, the AP 1618 may be connected to another network (for example, the Internet) without going through a CN 1624.

In embodiments, the UE 1602 and UE 1604 can be configured to communicate using orthogonal frequency division multiplexing (OFDM) communication signals with each other, with the terrestrial base station 1612, the terrestrial base station 1614, the satellite base station 1636, the satellite base station 1638, and/or the satellite 1642 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the terrestrial base station 1612, terrestrial base station 1614, the satellite base station 1636 and/or the satellite base station 1638 may be implemented as one or more software entities running on server computers as part of a virtual network.

In addition, or in other embodiments, the terrestrial base station 1612 or terrestrial base station 1614 may be configured to communicate with one another via interface 1622. In embodiments where the wireless communication system 1600 is an LTE system (e.g., when the CN 1624 is an EPC), the interface 1622 may be an X2 interface. The X2 interface may be defined between two or more base stations (e.g., two or more eNBs and the like) that connect to an EPC, and/or between two eNBs connecting to the EPC. It is contemplated than an inter-satellite link (ISL) may carry the X2 interface between in the case of two satellite base stations.

In embodiments where the wireless communication system 1600 is an NR system (e.g., when CN 1624 is a 5GC), the interface 1622 may be an Xn interface. An Xn interface is defined between two or more base stations that connect to 5GC (e.g., CN 1624). For example, the Xn interface may be between two or more gNBs that connect to 5GC, a gNB connecting to 5GC and an eNB, between two eNBs connecting to 5GC, and/or two or more satellite base stations via an ISL (as in, e.g., the interface 1640 between the satellite base station 1636 and the satellite base station 1638).

The RAN 1606 is shown to be communicatively coupled to the CN 1624. The CN 1624 may comprise one or more network elements 1626, which are configured to offer various data and telecommunications services to customers/subscribers (e.g., users of UE 1602 and UE 1604) who are connected to the CN 1624 via the RAN 1606. The components of the CN 1624 may be implemented in one physical device or separate physical devices including components to read and execute instructions from a machine-readable or computer-readable medium (e.g., a non-transitory machine-readable storage medium). For example, the components of the CN 1624 may be implemented in one or more processors and/or one or more associated memories.

In embodiments, the CN 1624 may be an EPC, and the RAN 1606 may be connected with the CN 1624 via an S1 interface 1628. In embodiments, the S1 interface 1628 may be split into two parts, an S1 user plane (S1-U) interface, which carries traffic data between the terrestrial base station 1612, terrestrial base station 1614, the satellite base station 1636, or the interface 1640 and a serving gateway (S-GW), and the S1-MME interface, which is a signaling interface between the terrestrial base station 1612, the terrestrial base station 1614 the satellite base station 1636, or the interface 1640 and mobility management entities (MMEs).

In embodiments, the CN 1624 may be a 5GC, and the RAN 1606 may be connected with the CN 1624 via an NG interface 1628. In embodiments, the NG interface 1628 may be split into two parts, an NG user plane (NG-U) interface, which carries traffic data between the terrestrial base station 1612, terrestrial base station 1614, satellite base station 1636, or satellite base station 1638 and a user plane function (UPF), and the S1 control plane (NG-C) interface, which is a signaling interface between the terrestrial base station 1612, terrestrial base station 1614 satellite base station 1636, or satellite base station 1638 and access and mobility management functions (AMFs).

Generally, an application server 1630 may be an element offering applications that use internet protocol (IP) bearer resources with the CN 1624 (e.g., packet switched data services). The application server 1630 can also be configured to support one or more communication services (e.g., VoIP sessions, group communication sessions, etc.) for the UE 1602 and UE 1604 via the CN 1624. The application server 1630 may communicate with the CN 1624 through an IP communications interface 1632.

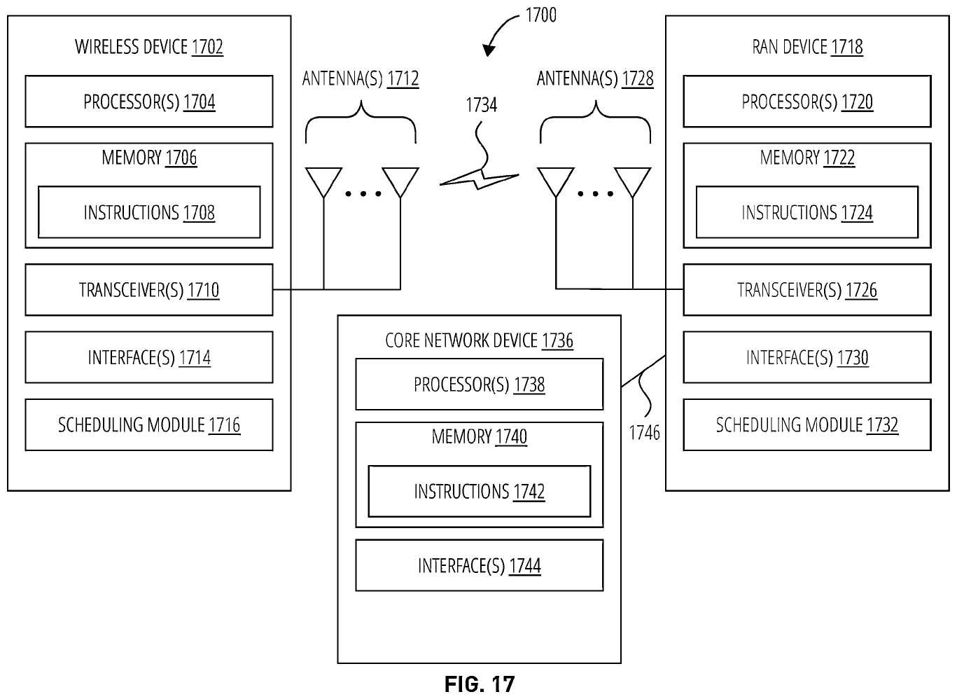

FIG. 17 illustrates a system 1700 for performing signaling 1734 between a wireless device 1702 and a RAN device 1718 connected to a core network of a CN device 1736, according to embodiments disclosed herein. The system 1700 may be a portion of a wireless communications system as herein described. The wireless device 1702 may be, for example, a UE of a wireless communication system. The RAN device 1718 may be, for example, a base station (e.g., an eNB or a gNB) of a wireless communication system that is a terrestrial base station or a satellite base station. In the case of a RAN device 1718 that is a terrestrial base station, the RAN device 1718 may be in communication with a satellite that directly provides radio access connectivity to a UE, in the manner described herein. The CN device 1736 may be one or more devices making up a CN, as described herein.

The wireless device 1702 may include one or more processor(s) 1704. The processor(s) 1704 may execute instructions such that various operations of the wireless device 1702 are performed, as described herein. The processor(s) 1704 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1702 may include a memory 1706. The memory 1706 may be a non-transitory computer-readable storage medium that stores instructions 1708 (which may include, for example, the instructions being executed by the processor(s) 1704). The instructions 1708 may also be referred to as program code or a computer program. The memory 1706 may also store data used by, and results computed by, the processor(s) 1704.

The wireless device 1702 may include one or more transceiver(s) 1710 that may include radio frequency (RF) transmitter and/or receiver circuitry that use the antenna(s) 1712 of the wireless device 1702 to facilitate signaling (e.g., the signaling 1734) to and/or from the wireless device 1702 with other devices (e.g., the RAN device 1718) according to corresponding RATs. In some embodiments, the antenna(s) 1712 may include a moving parabolic antenna, an omni-directional phased-array antenna, or some other antenna suitable for communication with a satellite, (e.g., as described above in relation to the UE 110 of FIG. 1 and the UE 208 of FIG. 2).

For a RAN device 1718 that is a terrestrial base station, the network device signaling 1734 may occur on a feeder link between the wireless device 1702 and a satellite and a service link between the satellite and the RAN device 1718 (e.g., as described in relation to FIG. 1). For a RAN device 1718 that is a satellite base station, the signaling 1734 may occur on a feeder link between the wireless device 1702 and the RAN device 1718 (e.g., as described in relation to FIG. 2).

The wireless device 1702 may include one or more antenna(s) 1712 (e.g., one, two, four, or more). For embodiments with multiple antenna(s) 1712, the wireless device 1702 may leverage the spatial diversity of such multiple antenna(s) 1712 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1702 may be accomplished according to precoding (or digital beamforming) that is applied at the wireless device 1702 that multiplexes the data streams across the antenna(s) 1712 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1702 may implement analog beamforming techniques, whereby phases of the signals sent by the antenna(s) 1712 are relatively adjusted such that the (joint) transmission of the antenna(s) 1712 can be directed (this is sometimes referred to as beam steering).

The wireless device 1702 may include one or more interface(s) 1714. The interface(s) 1714 may be used to provide input to or output from the wireless device 1702. For example, a wireless device 1702 that is a UE may include interface(s) 1714 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 1710/antenna(s) 1712 already described) that allow for communication between the UE and other devices and may operate according to known protocols (e.g., Wi-Fi®, Bluetooth®, and the like).

The wireless device 1702 may include a scheduling module 1716. The scheduling module 1716 may be implemented via hardware, software, or combinations thereof. For example, the scheduling module 1716 may be implemented as a processor, circuit, and/or instructions 1708 stored in the memory 1706 and executed by the processor(s) 1704. In some examples, the scheduling module 1716 may be integrated within the processor(s) 1704 and/or the transceiver(s) 1710. For example, the scheduling module 1716 may be implemented by a combination of software components (e.g., executed by a DSP or a general processor) and hardware components (e.g., logic gates and circuitry) within the processor(s) 1704 or the transceiver(s) 1710.

The scheduling module 1716 may be used for various aspects of the present disclosure, for example, aspects of FIG. 3 through FIG. 15. The scheduling module 1716 is configured to, for example, process ultra compact DCI and/or scheduling PDSCHs received at the wireless device 1702.

The RAN device 1718 may include one or more processor(s) 1720. The processor(s) 1720 may execute instructions such that various operations of the RAN device 1718 are performed, as described herein. The processor(s) 1704 may include one or more baseband processors implemented using, for example, a CPU, a DSP, an ASIC, a controller, an FPGA device, another hardware device, a firmware device, or any combination thereof configured to perform the operations described herein.

The RAN device 1718 may include a memory 1722. The memory 1722 may be a non-transitory computer-readable storage medium that stores instructions 1724 (which may include, for example, the instructions being executed by the processor(s) 1720). The instructions 1724 may also be referred to as program code or a computer program. The memory 1722 may also store data used by, and results computed by, the processor(s) 1720.

The RAN device 1718 may include one or more transceiver(s) 1726 that may include RF transmitter and/or receiver circuitry that use the antenna(s) 1728 of the RAN device 1718 to facilitate signaling (e.g., the signaling 1734) to and/or from the RAN device 1718 with other devices (e.g., the wireless device 1702) according to corresponding RATs.

The RAN device 1718 may include one or more antenna(s) 1728 (e.g., one, two, four, or more). In embodiments having multiple antenna(s) 1728, the RAN device 1718 may perform MIMO, digital beamforming, analog beamforming, beam steering, etc., as has been described.

For a RAN device 1718 that is a terrestrial base station, one or more of the transceiver(s) 1726 and/or the antenna(s) 1728 may instead be present on a satellite gateway associated with the base station (e.g., as shown in reference to the terrestrial base station 104 and the satellite gateway 106 of FIG. 1). For a RAN device 1718 that is a satellite base station, the transceiver(s) 1726 and/or the antenna(s) 1728 may be present on the satellite, and one or more of those antenna(s) 1728 may be antenna(s) appropriate for satellite communication (such as a moving parabolic antenna, an omni-directional phased-array antenna, etc.)

The RAN device 1718 may include one or more interface(s) 1730. The interface(s) 1730 may be used to provide input to or output from the RAN device 1718. For example, a RAN device 1718 that is a base station may include interface(s) 1730 made up of transmitters, receivers, and other circuitry (e.g., other than the transceiver(s) 1726/antenna(s) 1728 already described) that enables the base station to communicate with other equipment in a CN, and/or that enables the base station to communicate with external networks, computers, databases, and the like for purposes of operations, administration, and maintenance of the base station or other equipment operably connected thereto.

The RAN device 1718 may include a scheduling module 1732. The scheduling module 1732 may be implemented via hardware, software, or combinations thereof. For example, the scheduling module 1732 may be implemented as a processor, circuit, and/or instructions 1724 stored in the memory 1722 and executed by the processor(s) 1720. In some examples, the scheduling module 1732 may be integrated within the processor(s) 1720 and/or the transceiver(s) 1726. For example, the scheduling module 1732 may be implemented by a combination of software components (e.g., executed by a DSP or a general processor) and hardware components (e.g., logic gates and circuitry) within the processor(s) 1720 or the transceiver(s) 1726.

The scheduling module 1732 may be used for various aspects of the present disclosure, for example, aspects of FIG. 3 through FIG. 15. The scheduling module 1732 is configured to, for example, generate and/or transmit ultra compact DCI and/or scheduling PDSCHs sent by the RAN device 1718.

The RAN device 1718 may communicate with the CN device 1736 via the interface 1746, which may be analogous to the interface 1628 of FIG. 16 (e.g., may be an S1 and/or NG interface, either of which may be split into user plane and control plane parts).

The CN device 1736 may include one or more processor(s) 1738. The processor(s) 1738 may execute instructions such that various operations of the CN device 1736 are performed, as described herein. The processor(s) 1738 may include one or more baseband processors implemented using, for example, a CPU, a DSP, an ASIC, a controller, an FPGA device, another hardware device, a firmware device, or any combination thereof configured to perform the operations described herein.

The CN device 1736 may include a memory 1740. The memory 1740 may be a non-transitory computer-readable storage medium that stores instructions 1742 (which may include, for example, the instructions being executed by the processor(s) 1738). The instructions 1742 may also be referred to as program code or a computer program. The memory 1740 may also store data used by, and results computed by, the processor(s) 1738.

The CN device 1736 may include one or more interface(s) 1744. The interface(s) 1744 may be used to provide input to or output from the CN device 1736. For example, a CN device 1736 may include interface(s) 1730 made up of transmitters, receivers, and other circuitry that enables the CN device 1736 to communicate with other equipment in the CN, and/or that enables the CN device 1736 to communicate with external networks, computers, databases, and the like for purposes of operations, administration, and maintenance of the CN device 1736 or other equipment operably connected thereto.

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
receiving a system information block (SIB) from a base station, the SIB comprising:
first configuration information for an ultra compact downlink control information (DCI); and
second configuration information for one or more scheduling physical downlink shared channels (PDSCHs);
receiving, from the base station, the ultra compact DCI, wherein the ultra compact DCI corresponds to the first configuration information; and
receiving, from the base station, the one or more scheduling PDSCHs, wherein the one or more scheduling PDSCHs correspond to the second configuration information.

2. The method of claim 1, wherein the first configuration information for the ultra compact DCI comprises one or more of:
a resource mapping rule for identifying resources used by the one or more scheduling PDSCHs relative to resources used by the ultra compact DCI;
a number of physical downlink control channel (PDCCH) repetitions that carry repetitions of the ultra compact DCI;
an indication of one or more fields that are used in the ultra compact DCI; and
an indication of whether a new data indicator (NDI) field is included in the ultra compact DCI.

3. The method of claim 1, wherein the SIB further comprises numerology information for a physical downlink control channel (PDCCH) that carries the ultra compact DCI.

4. The method of claim 1, wherein the second configuration information for the one or more scheduling PDSCHs comprises one or more of:
modulation and coding scheme (MCS) information for the one or more scheduling PDSCHs;
a hybrid automatic repeat request (HARQ) process number for the one or more scheduling PDSCHs;
a redundancy version (RV) for the scheduling PDSCHs;
a number of PDSCH repetitions within the one or more scheduling PDSCHs;
a maximum number of layers of the one or more scheduling PDSCHs; and
an aggregation level of the one or more scheduling PDSCHs.

5. A method of a user equipment (UE), comprising:
receiving, from a base station, an ultra compact downlink control information (DCI) comprising first fields for one or more scheduling physical downlink shared channels (PDSCHs) that schedule a data PDSCH;
receiving, from the base station, the one or more scheduling PDSCHs, wherein the one or more scheduling PDSCHs correspond to data of the first fields; and
receiving, from the base station, the data PDSCH as scheduled by the one or more scheduling PDSCHs.

6. The method of claim 5, wherein the first fields for the one or more scheduling PDSCHs comprise one or more of:
a time domain resource allocation (TDRA) table index field for the one or more scheduling PDSCHs;
a frequency domain resource allocation (FDRA) field for the one or more scheduling PDSCHs;
a modulation and coding scheme (MCS) field for the one or more scheduling PDSCHs;
a redundancy version (RV) field for the one or more scheduling PDSCHs;
a hybrid automatic repeat request (HARQ) process number field for the one or more scheduling PDSCHs;
a new data indicator (NDI) field for the one or more scheduling PDSCHs;
a downlink assignment indicator (DAI) field for the one or more scheduling PDSCHs; and
a number of PDSCH repetitions field for the one or more scheduling PDSCHs.

7. The method of claim 6, wherein one or more of the MCS field, the RV field, the HARQ process number field, the NDI field, the DAI field, and the number of PDSCH repetitions field comprises fixed data.

8. The method of claim 5, further comprising transmitting, to the base station, a physical uplink control channel (PUCCH) comprising first hybrid automatic repeat request (HARQ) acknowledgement (HARQ-ACK) signaling for the one or more scheduling PDSCHs, wherein the ultra compact DCI further comprises second fields for the first HARQ-ACK signaling for the one or more scheduling PDSCHs.

9. The method of claim 8, wherein the second fields for the first HARQ-ACK signaling comprise one or more of:
a PUCCH resource indicator field for the first HARQ-ACK signaling;
a transmit power control (TPC) command field for the first HARQ-ACK signaling; and
a PDSCH-to-HARQ feedback timing indicator field for the first HARQ-ACK signaling.

10. The method of claim 9, wherein one or more of the PUCCH resource indicator field, the TPC command field, and the PDSCH-to-HARQ_feedback timing indicator field that is present in the ultra compact DCI comprises fixed data.

11. The method of claim 8, wherein the PUCCH further comprises second HARQ-ACK signaling for the data PDSCH.

12. The method of claim 5, wherein the ultra compact DCI is received in a physical downlink control channel (PDCCH) having cyclic redundancy check (CRC) bits that are scrambled by one of:
a cell radio network temporary identifier (RNTI) (C-RNTI);
a configured scheduling RNTI (CS-RNTI);
a modulation and coding scheme cell RNTI (MCS-C-RNTI);
a random access RNTI (RA-RNTI);
a temporary cell RNTI (TC-RNTI);
a paging RNTI (P-RNTI); and
a system information RNTI (SI-RNTI).

13. The method of claim 5, wherein the ultra compact DCI is received in one or more physical downlink control channel (PDCCH) repetitions.

14. The method of claim 5, wherein the ultra compact DCI is received in one or more of a plurality of physical downlink control channels (PDCCHs), wherein each of the plurality of PDCCHs is transmitted by a different transmission reception point (TRP).

15. The method of claim 14, wherein each of the plurality of PDCCHs is associated with a different search space set.

16. The method of claim 14, wherein the plurality of PDCCHs is one or more of time division multiplexed (TDMed), frequency division multiplexed (FDMed), and spatial division multiplexed (SDMed).

17. The method of claim 14, wherein each of the plurality of PDCCHs is identical.

18. The method of claim 5, wherein the ultra compact DCI has a first payload size that is smaller than a second payload size of a compact DCI.

19. The method of claim 5, wherein the ultra compact DCI is of DCI format 1_2.

20. A method of a user equipment (UE), comprising:
receiving, from a base station, an ultra compact downlink control information (DCI) comprising first fields for one or more scheduling physical downlink shared channels (PDSCHs) that schedule a physical uplink shared channel (PUSCH); and
receiving, from the base station, the one or more scheduling PDSCHs, wherein the one or more scheduling PDSCHs correspond to data of the first fields; and
transmitting, to the base station, the PUSCH as scheduled by the one or more scheduling PDSCHs.

21-37. (canceled)
